(19) United States
(12) Patent Application Publication
(10) Pub. No.: US 2025/0136457 A1
(43) Pub. Date: May 1, 2025

(54) GEOTHERMALLY DRIVEN AMMONIA PRODUCTION

(71) Applicant: EnhancedGEO Holdings, LLC, St. Petersburg, FL (US)

(72) Inventors: Greg Lindberg, Thonotosassa, FL (US); Kimberly C. Conner, Wetumpka, AL (US)

(21) Appl. No.: 18/497,564

(22) Filed: Oct. 30, 2023

(51) Int. Cl. C01C 1/04; B01D 3/14; B01D 53/047; C01B 21/04; C25B 1/04; C25B 15/021; C25B 15/08

(52) U.S. Cl. CPC C01C 1/0417; B01D 3/14; B01D 53/047; C01B 21/0461; C25B 1/04; C25B 15/021; C25B 15/08; B01D 2253/102; B01D 2253/116; B01D 2256/10; B01D 2257/104; B01D 2257/80; C01B 2210/0017; C01B 2210/0045; C01B 2210/0062

(57) ABSTRACT

Apparatus, system, and method for geothermally driven ammonia production. Hydrogen is generated using energy obtained from the underground magma reservoir and nitrogen is captured from air using the energy obtained from the underground magma reservoir. At least a portion of the generated hydrogen is combined with at least a portion of the generated nitrogen and heated at least to a reaction temperature using the energy obtained from the underground magma reservoir. The heated hydrogen contacts the heated nitrogen for a residence time to form the ammonia.

### TECHNICAL FIELD

The present disclosure relates generally to ammonia production, and more particularly to geothermally driven ammonia production.

### BACKGROUND

Ammonia (NH₃) has several established uses in agriculture and industry. More recent technological developments have also shown that ammonia can be viable fuel with applications in energy production, transportation, and the like. Given the expanding usefulness of ammonia, there exists a need for improved processes for generating ammonia.

### SUMMARY

Ammonia is conventionally obtained using energy-intensive processes that consume non-renewable resources, such as fossil fuels. As such, the energy input required for conventional ammonia production results in a considerable environmental impact via the burning of fossil fuels. While solar power and wind power are commonly available sources of renewable energy, both can be unreliable and have relatively low power densities compared to the energy inputs needed for ammonia production.

This disclosure recognizes that geothermal energy with a sufficiently high power density can be used to efficiently and effectively facilitate ammonia production processes. Furthermore, this disclosure provides a solution to shortcomings of previous ammonia production technology in the form of a geothermally powered ammonia production system. A geothermal system harnesses heat from a geothermal resource, such as magma, with a sufficiently high temperature that can be used to provide necessary operating temperatures and power equipment used for ammonia production. For example, a heated fluid, such as steam, may be obtained from a geothermal system, and the heated fluid may be used to drive processes involved in ammonia production. In some cases, the heated fluid is used to drive hydrogen production operations. In some cases, the heated fluid is used to drive nitrogen production (and/or nitrogen capture) operations. Nitrogen and hydrogen are combined to form ammonia. Energy inputs for ammonia formation may also be provided from the geothermal system. For instance, high temperatures for ammonia synthesis may be provided using geothermally derived energy, while cooling used to separate desired products may also be provided through geothermal energy. For example, a thermally powered chiller, such as an absorption or adsorption chiller, may use heated fluid from the geothermal system to provide cooling for separations or other processes.

In some cases, temperature adjustments or control may be achieved using heated fluid from the geothermal system and/or cooling from a thermally powered chiller. In this way, for example, ammonia production can be improved by operating at temperatures that facilitate more effective hydrogen generation, nitrogen generation, and/or ammonia production. In some cases, mechanical components of the geothermally powered ammonia production system, such as mixers and/or pumps, may be powered by geothermal energy. For instance, steam obtained from geothermal heat may be used to move motors that impart movements to mechanical components. In some cases, one or more turbines may be powered by the heated fluid from the geothermal system to provide electricity for some or all electronic components of the ammonia production system (e.g., electrolyzers, electronic controllers, sensors, etc.). In some cases, one or more reactions may be performed in a reaction chamber or vessel that is located inside a wellbore. For example, the reaction chamber or vessel may be located at a depth that provides a reaction temperature needed to drive a given process, such as for hydrogen generation and/or ammonia synthesis. The reaction chamber or vessel may be located at a depth that is inside a magma reservoir into which the wellbore extends.

The geothermal systems of this disclosure may harness a geothermal resource with sufficiently high amounts of energy from magmatic activity such that the geothermal resource does not degrade significantly over time. This disclosure illustrates improved systems and methods for capturing energy from magma reservoirs, including dikes, sills, and other magmatic formations, that are significantly higher in temperature than heat sources that are accessed using previous geothermal technologies and that can have an order of magnitude higher energy density than the geothermal fluids that power previous geothermal technologies. In some cases, the present disclosure can significantly decrease ammonia production costs and/or reliance on non-renewable resources for ammonia production. In some cases, the present disclosure may facilitate more efficient ammonia production both in general and in regions where access to reliable power is currently unavailable or transport of non-renewable fuels is challenging.

Certain embodiments may include none, some, or all of the above technical advantages. One or more technical advantages may be readily apparent to one skilled in the art from figures, description, and claims included herein.

### BRIEF DESCRIPTION OF THE FIGURES

For a more complete understanding of the present disclosure, reference is now made to the following description, taken in conjunction with the accompanying drawings and detailed description, in which like reference numerals represent like parts.

FIG. 1 is a diagram of underground regions near a tectonic plate boundary in the Earth.

FIG. 2 is a diagram of a conventional geothermal system.

FIG. 3 is a diagram of an example improved geothermal system of this disclosure.

FIG. 4 is a diagram of an example geothermally powered ammonia production system.

FIG. 5 is a diagram showing an example ammonia production system of the system of FIG. 4.

FIG. 6A is a diagram of a system for thermochemical splitting of water for use in the system of FIG. 5.

FIG. 6B is a diagram of another example system for thermochemical splitting of water for use in the system of FIG. 5.

FIG. 7A is a diagram of another example system for thermochemical splitting of water for use in the system of FIG. 5.

FIG. 7B is a diagram of another example system for thermochemical splitting of water for use in the system of FIG. 5.

FIG. 8A is a diagram of another example system for thermochemical splitting of water for use in the system of FIG. 5.

FIG. 8B is a diagram of another example system for thermochemical splitting of water for use in the system of FIG. 5.

FIG. 9A is a diagram of another example system for thermochemical splitting of water for use in the system of FIG. 5.

FIG. 9B is a diagram of yet another example system for thermochemical splitting of water for use in the system of FIG. 5.

FIG. 10 is a flowchart of an example method for geothermally driven thermochemical splitting of water for use in the system of FIG. 5.

FIG. 11 is a diagram of an example hydrogen generation system for use in the system of FIG. 5.

FIG. 12 is a diagram of another example hydrogen generation system for use in the system of FIG. 5.

FIG. 13 is a flowchart of an example method for operating the systems of FIGS. 11 and 12.

FIG. 14 is a diagram of an example system for nitrogen generation for use in the system of FIG. 5.

FIG. 15 is a diagram of another example system for nitrogen generation for use in the system of FIG. 5.

FIG. 16 is a diagram of an example system for forming ammonia that may be used in the system of FIG. 5.

FIG. 17 is a diagram of another example system for forming ammonia that may be used in the system of FIG. 5

FIG. 18 is a diagram of another example system for forming ammonia that may be used in the system of FIG. 5.

FIG. 19 is a diagram of another example system for forming ammonia that may be used in the system of FIG. 5.

FIG. 20 is a diagram of example recovery equipment for use with a system for forming ammonia.

FIG. 21 is a flowchart of an example process for carrying out a thermochemical process.

FIG. 22 is a flowchart of an example process for processing a product stream formed by a thermochemical process.

FIGS. 23A and 23B are diagrams of example systems for electrochemical ammonia generation that may be used in the system of FIG. 5.

FIG. 24 is a flowchart of an example method for operating the systems of FIGS. 23A and 23B.

FIG. 25 is a diagram of an example system for performing thermal processes of FIGS. 3 and 4.

FIG. 26 is a diagram of an example controller for use with the various systems of this disclosure.

### DETAILED DESCRIPTION

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

As used herein, “magma” refers to extremely hot liquid and semi-liquid rock under the Earth's surface. Magma is formed from molten or semi-molten rock mixture found typically between 1 km to 10 km under the surface of the Earth. However, magma can be found at shallower depths in some cases. As used herein, “borehole” refers to, including oil, gas, water, or heat from below the surface of the Earth. As used herein, a “wellbore” refers to a borehole either alone or in combination with one or more other components disposed within or in connection with the borehole. In some cases, the terms “wellbore” and “borehole” are used interchangeably. As used herein, “heat transfer fluid” refers to a fluid, e.g., a gas or liquid, that takes part in heat transfer by serving as an intermediary in cooling on one side of a process, transporting and storing thermal energy, and heating on another side of a process. Heat transfer fluids are used in processes involving heating or cooling.

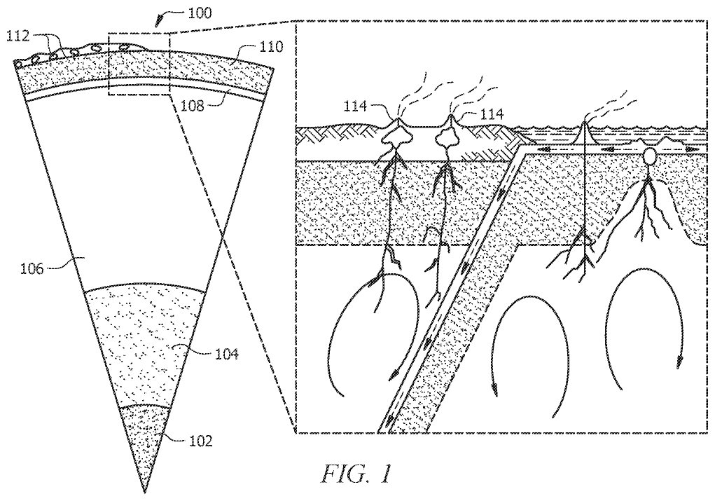

FIG. 1 is a partial cross-sectional diagram 100 of the Earth depicting underground formations that can be tapped by geothermal systems of this disclosure (e.g., for generating geothermal power). The Earth is composed of an inner core 102, outer core 104, lower mantle 106, transitional region 108, upper mantle 110, and crust 112. There are places on the Earth where magma reaches the surface of the crust 112 forming volcanoes 114. However, in most cases, magma approaches only within a few miles or less from the surface. This magma can heat ground water to temperatures sufficient for certain geothermal power production. However, for other applications, such as geothermal energy production, more direct heat transfer with magma is desirable.

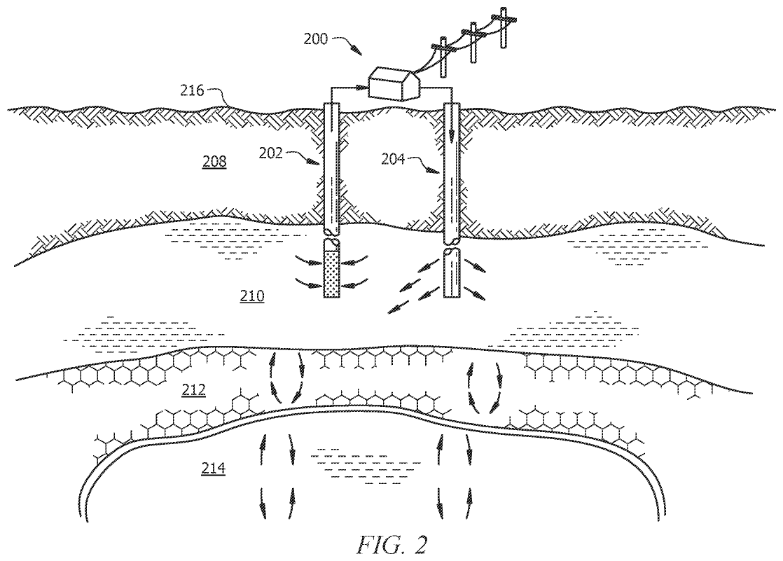

FIG. 2 illustrates a conventional geothermal system 200 that harnesses energy from heated ground water for power generation. The conventional geothermal system 200 is a “flash-plant” that generates power from a high-temperature, high-pressure geothermal water extracted from a production well 202. The production well 202 is drilled through rock layer 208 and into the hydrothermal layer 210 that serves as the source of geothermal water. The geothermal water is heated indirectly via heat transfer with intermediate layer 212, which is in turn heated by magma reservoir 214. Magma reservoir 214 can be any underground region containing magma such as a dike, sill, or the like. Convective heat transfer (illustrated by the arrows indicating that hotter fluids rise to the upper portions of their respective layers before cooling and sinking, then rising again) may facilitate heat transfer between these layers. Geothermal water from the hydrothermal layer 210 flows to the surface 216 and is used for geothermal power generation. The geothermal water (and possibly additional water or other fluids) is then injected back into the hydrothermal layer 210 via an injection well 204.

The configuration of conventional geothermal system 200 of FIG. 2 suffers from drawbacks and disadvantages, as recognized by this disclosure. For example, because geothermal water is a multicomponent mixture (i.e., not pure water), the geothermal water flashes at various points along its path up to the surface 216, creating water hammer, which results in a large amount of noise and potential damage to system components. The geothermal water is also prone to causing scaling and corrosion of system components. Chemicals may be added to partially mitigate these issues, but this may result in considerable increases in operational costs and increased environmental impacts, since these chemicals are generally introduced into the environment via injection well 204. Temperatures achieved with a conventional geothermal system 200 are not generally sufficient for driving the range of processes needed for ammonia production.

### Example Improved Geothermal System

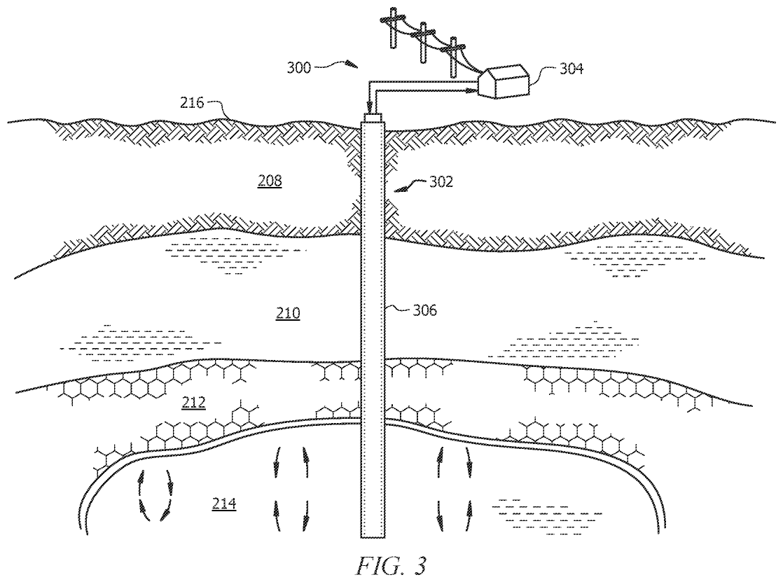

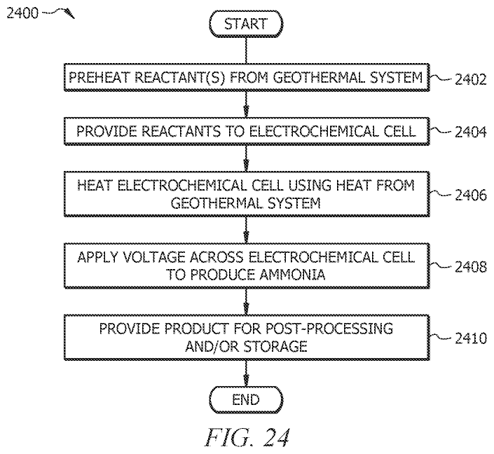

FIG. 3 illustrates an example magma-based geothermal system 300 of this disclosure. The magma-based geothermal system 300 includes a wellbore 302 that extends from the surface 216 at least partially into the magma reservoir 214. A heat exchanger 306 may be located inside the wellbore 302. The magma-based geothermal system 300 is a closed system in which a heat transfer fluid is provided down the wellbore 302 to be heated and returned to a thermal process system 304 (e.g., for power generation and/or any other thermal processes of interest). As such, geothermal water is not extracted from the Earth, resulting in significantly reduced risks associated with the conventional geothermal system 200 of FIG. 2, as described further below. Heated heat transfer fluid is provided to the thermal process system 304. The thermal process system 304 is generally any system that uses the heat transfer fluid to drive a process of interest. For example, the thermal process system 304 may include an electricity generation system and/or support thermal processes requiring higher temperatures/pressures than could be reliably or efficiently obtained using previous geothermal technology, such as the conventional geothermal system 200 of FIG. 2. Further details of components of an example thermal process system 304 are provided with respect to FIG. 25 below.

The magma-based geothermal system 300 provides technical advantages over previous geothermal systems, such as the conventional geothermal system 200 of FIG. 2. The magma-based geothermal system 300 can achieve higher temperatures and pressures for increased energy generation and/or for more effectively driving other thermal processes, such as for ammonia production. For example, because of the high energy density of magma in magma reservoir 214 (e.g., compared to that of geothermal water of the geothermal fluid layer 210), wellbore 302 can generally create the power of many wells of the conventional geothermal system 200 of FIG. 2. Furthermore, the heat transfer fluid is generally not substantially released into the geothermal zone, resulting in a decreased environmental impact and decreased use of costly materials (e.g., chemical additives that are used and introduced to the environment in great quantities during some conventional geothermal operations). The magma-based geothermal system 300 may also have a simplified design and operation compared to those of previous systems. For instance, fewer components and reduced complexity may be needed at the thermal process system 304 because only relatively clean heat transfer fluid (e.g., steam) reaches the surface 216. There may be no need or a reduced need to separate out solids or other impurities that are common to geothermal water. The example magma-based geothermal system 300 may include further components not illustrated in FIG. 3.

Further details and examples of different configurations of geothermal systems and methods of their preparation and operation are described in U.S. patent application Ser. No. 18/099,499, filed Jan. 20, 2023, and titled “Geothermal Power from Superhot Geothermal Fluid and Magma Reservoirs”; U.S. patent application Ser. No. 18/099,509, filed Jan. 20, 2023, and titled “Geothermal Power from Superhot Geothermal Fluid and Magma Reservoirs”; U.S. patent application Ser. No. 18/099,514, filed Jan. 20, 2023, and titled “Geothermal Power from Superhot Geothermal Fluid and Magma Reservoirs”; U.S. patent application Ser. No. 18/099,518, filed Jan. 20, 2023, and titled “Geothermal Power from Superhot Geothermal Fluid and Magma Reservoirs”; U.S. patent application Ser. No. 18/105,674, filed Feb. 3, 2023, and titled “Wellbore for Extracting Heat from Magma Chambers”; U.S. patent application Ser. No. 18/116,693, filed Mar. 2, 2023, and titled “Geothermal systems and methods with an underground magma chamber”; U.S. patent application Ser. No. 18/116,697, filed Mar. 2, 2023, and titled “Method and system for preparing a geothermal system with a magma chamber”; U.S. patent application Ser. No. 18/195,810, filed May 10, 2023, and titled “Reverse-Flow Magma-Based Geothermal Generation”, U.S. patent application Ser. No. 18/195,814, filed May 10, 2023, and titled “Partially Cased Wellbore in Magma Reservoir”; U.S. patent application Ser. No. 18/195,822, filed May 10, 2023, and titled “Geothermal System With a Pressurized Chamber in a Magma Wellbore”; U.S. patent application Ser. No. 18/195,828, filed May 10, 2023, and titled “Magma Wellbore With Directional Drilling”; U.S. patent application Ser. No. 18/195,837, filed May 10, 2023, and titled “Molten Salt as Heat Transfer Fluid in Magma Geothermal System”; and U.S. patent application Ser. No. 18/141,326, filed Feb. 28, 2023, and titled “Casing a wellbore in magma”, the entirety of each of which is hereby incorporated by reference.

### Geothermally Powered Ammonia Production

Geothermal systems have been proposed to offset the high cost of carrying out thermochemical processes. However, these conventional geothermal systems generate electricity by using steam from production wells. This electricity is then inefficiently stored and transported over long distances to power a conventional heating apparatus that drives thermochemical processes. The numerous steps of converting geothermal energy into electricity, transporting the electricity, and then converting the electricity back into thermal energy is inefficient and significantly limits the practical applications of geothermal energy for many processes. Other forms of renewable energy, such as solar and wind, are unpredictable and inefficient, and still require the inefficient transformations between electrical and thermal energy described above.

This disclosure provides improved systems and methods for leveraging renewable geothermal energy to drive thermochemical processes for ammonia generation without the unavoidable costs, inefficiencies, and unpredictability of conventional systems and methods. In particular, the improved systems and methods may facilitate ammonia synthesis that is fully powered by a geothermal well without using a supplemental energy source (e.g., from burning fossil fuels).

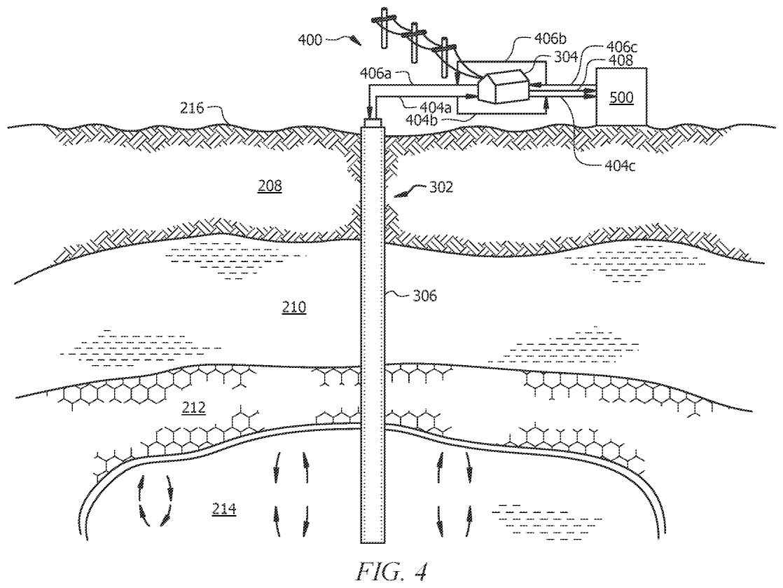

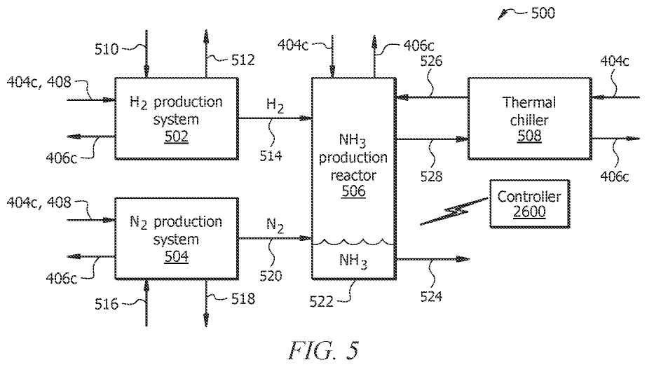

FIG. 4 illustrates an example combined geothermal and ammonia production system 400 of this disclosure. The combined geothermal and ammonia production system 400 includes all or a portion of the components of the magma-based geothermal system 300 described above with respect to FIG. 3 as well as geothermally powered ammonia production system 500 for producing ammonia. The combined geothermal and ammonia production system 400 may include all or a portion of the thermal process system 304. An example of the geothermally powered ammonia production system 500 is described in greater detail below with respect to FIG. 5. While shown for simplicity and conciseness in FIG. 5 as a system located on surface 216, geothermally powered ammonia production system 500 may include components that are located within the wellbore 302. For instance, as described in greater detail with respect to various examples below, reaction chambers for hydrogen generation and/or ammonia production may be located within the wellbore 302.

In an example operation of the geothermally powered ammonia production system 500, heat transfer fluid is injected into the wellbore 302, which extends from the surface 216 into the magma reservoir 214 underground. The heated heat transfer fluid 404a can be conveyed to the thermal process system 304 that can be used to drive processes, such as the generation of electricity 408 by turbines (see, e.g., sets of turbines 2504 and 2508 in FIG. 25). Heat transfer fluid 404c, which can be formed from any remaining amount of heat transfer fluid 404a (e.g., steam) exiting from the thermal process system 304 and/or a wellbore bypass stream (i.e., heat transfer fluid 404b) is provided to the geothermally powered ammonia production system 500. The electricity 408 may be used in addition to or in place of heat transfer fluid 404c for powering electrical and/or mechanical processes in the geothermally powered ammonia production system 500, as described in greater detail below.

As described in greater detail below with respect to FIG. 5, the geothermally powered ammonia production system generates reactants (e.g., hydrogen and nitrogen) using geothermally derived energy and causes the reactants to react to form ammonia. As an example, the geothermally powered ammonia production system may use the heat transfer fluid 404c, which may be waste heat from thermal process system 304 and/or heated heat transfer fluid directly from the wellbore 302, to help facilitate ammonia synthesis. Electricity 408 may provide electrical power for various operations that may be used for ammonia production, such as for driving electrolytic water splitting for hydrogen production, driving electrolytic nitrogen reduction for ammonia formation, compressing and/or cooling air for nitrogen capture, and the like. The produced ammonia is stored or transported to some downstream process (not shown for conciseness).

Heat transfer fluid 406a (e.g., condensed steam) that is cooled and/or or decreased in pressure after powering the geothermally powered ammonia production system 500 may be returned to the wellbore 302. For instance, as shown in the example of FIG. 4, a stream of return heat transfer fluid 406c may be provided back to the thermal process system 304, optionally used to drive one or more reactions or processes, and then expelled as heat transfer fluid 406a for return to the wellbore 302. The heat transfer fluid 406a can also include a bypass stream of heat transfer fluid 406b. Restated, thermally processed return stream of heat transfer fluid 406a includes heat transfer fluid (e.g., condensed steam) from the thermal process system 304 and/or the bypass stream of heat transfer fluid 406b. Thermally processed return stream of heat transfer fluid 406a that is sent back to the wellbore 302 may be water (or another heat transfer fluid), while the stream of heat transfer fluid 404a received from the wellbore 302 may be steam or another heat transfer fluid at an elevated temperature and/or pressure. While the example of FIG. 4 includes the thermal process system 304 of FIG. 3, in some cases, the combined geothermal and ammonia production system 400 may exclude all or a portion of the thermal process system 304. For example, the wellbore stream of heat transfer fluid 404a from the wellbore 302 may be provided directly to the geothermally powered ammonia production system 500 (see wellbore bypass stream of heat transfer fluid 404b described above).

Heat transfer fluid 404a-c, 406a-c may be any appropriate fluid for absorbing heat within the wellbore 302 and driving operations of the geothermally powered ammonia production system 500 and, optionally the thermal process system 304. For example, the heat transfer fluid may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). A molten salt is a salt that is a liquid at the high operating temperatures experienced in the wellbore 302 (e.g., at temperatures between 1,600 and 2,300° F.). In some cases, an ionic liquid may be used as the heat transfer fluid. An ionic liquid is a salt that remains a liquid at more modest temperatures (e.g., at or near room temperature). In some cases, a nanofluid may be used as the heat transfer fluid. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluids in the wellbore 302. For example, molten salts and/or ionic liquids may be stable at the high temperatures that can be reached in the wellbore 302. The high temperatures that can be achieved by these materials not only facilitate increased energy extraction but also can drive thermal processes that were previously inaccessible using previous geothermal technology. The heat transfer fluid may be selected at least in part to limit the extent of corrosion of surfaces of the combined geothermal and ammonia production system 400. As an example, the heat transfer fluid may be water. The water is supplied to the wellbore 302 as stream of heat transfer fluid 406a in the liquid phase and is transformed into steam within the wellbore 302. The steam is received as stream of heat transfer fluid 404a and used to drive the geothermally powered ammonia production system 500.

### Example Geothermally Powered Ammonia Production System

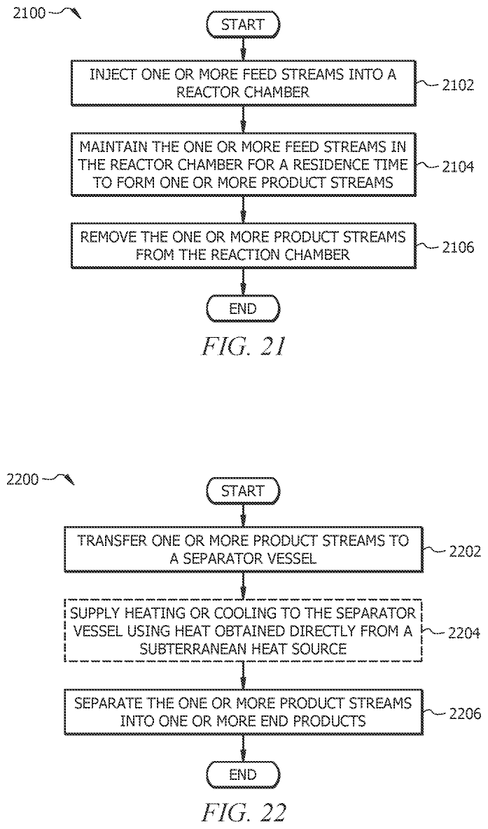

FIG. 5 shows an example geothermally powered ammonia production system 500 that may be used in the system 400 of FIG. 4. Example geothermally powered ammonia production system 500 includes a hydrogen production subsystem 502, a nitrogen production subsystem 504, and an ammonia production reactor 506. The hydrogen production subsystem 502 includes a hydrogen-generation reactor that generates hydrogen 514 using energy obtained from the magma reservoir 214 (e.g., through positioning of hydrogen production subsystem 502 in the wellbore 302 or using heat transfer fluid 404c). The nitrogen production subsystem 504 captures or separates nitrogen 520 from air 516 using energy obtained from the magma reservoir (e.g., by powering separation processes, such as compression and cooling using energy from heat transfer fluid 404c and/or electricity 408). The ammonia production reactor 506 includes a reaction chamber that receives at least a portion of the hydrogen 514 generated by the hydrogen production subsystem 502 and at least a portion of the nitrogen 520 captured by the nitrogen production subsystem 504. The hydrogen 514 and nitrogen 520 are combined in the ammonia production reactor 506 to form ammonia 522. For example, the hydrogen 514 and nitrogen 520 may be heated to a reaction temperature sufficient to support ammonia synthesis using heat transfer fluid 404c. The example geothermally powered ammonia production system 500 may include more or fewer components. For example, in some cases, hydrogen 514 may not be generated, for instance, when the ammonia production reactor 506 employs an approach to ammonia synthesis that does not require hydrogen (see, e.g., FIG. 23B).

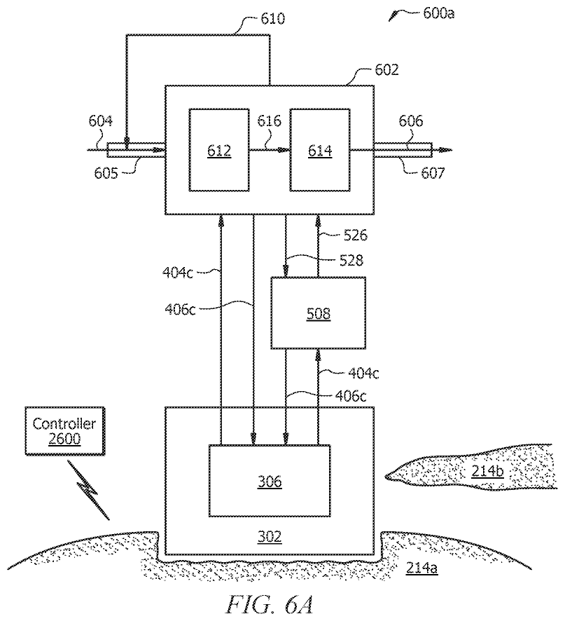

The hydrogen production subsystem 502 receives a feed stream 510 and outputs hydrogen 514 and any byproducts 512 of the hydrogen generation process. The feed stream 510 may include water, steam, and optionally catalysts or other compounds that facilitate hydrogen generation. Byproducts 512 may include oxygen and residual reactant. In some embodiments, all or some of the byproducts 512 can be returned to the hydrogen production subsystem 502 in a recycle stream to improve efficiency and/or reduce waste. Further details of example hydrogen generation processes are described in greater detail below with respect to FIGS. 6A-13.

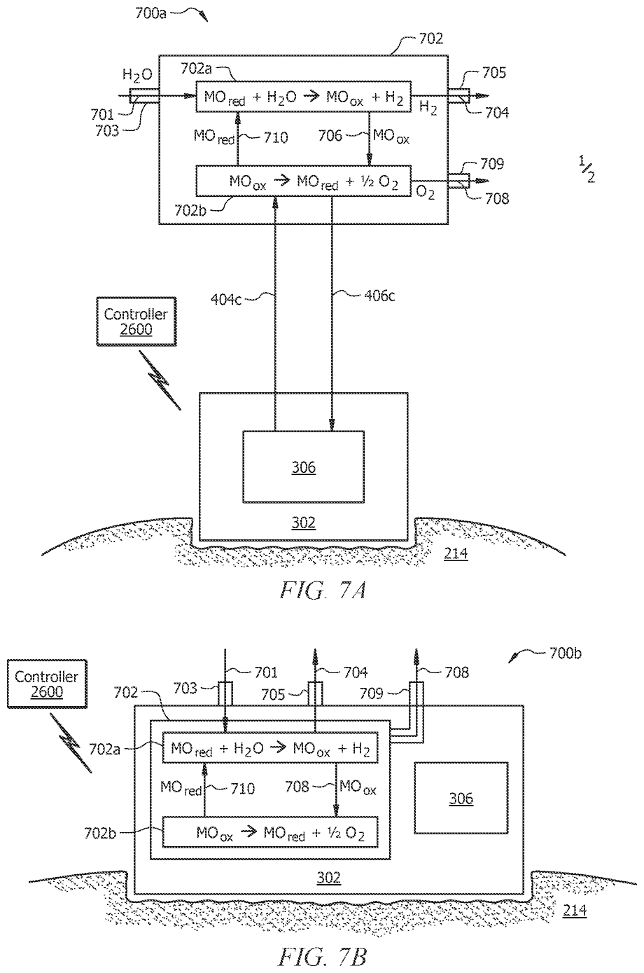

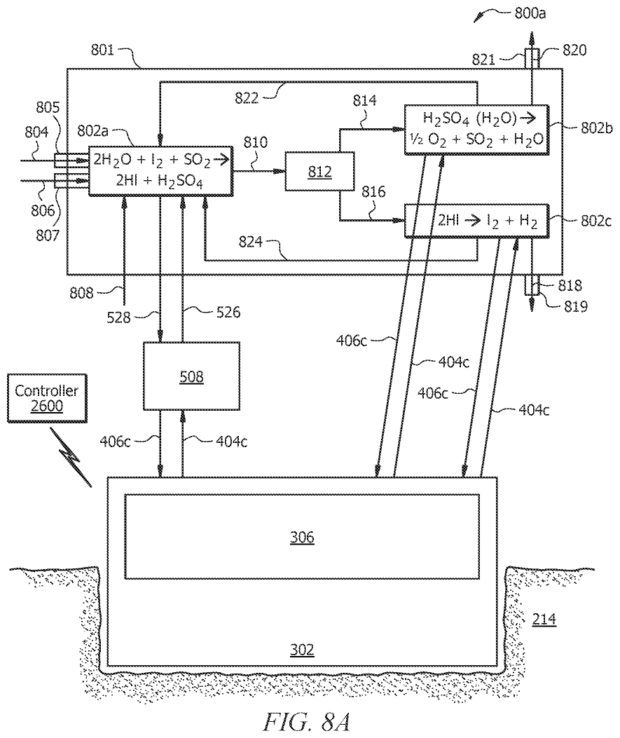

In the example of FIG. 5, the hydrogen production subsystem 502 receives energy from the magma reservoir 214 in the form of heated heat transfer fluid 404c and/or electricity 408. Cooled heat transfer fluid 406c may be output from the hydrogen production subsystem 502. In some cases, the hydrogen production subsystem 502 is or includes a vessel at a temperature sufficient to support thermochemical water splitting (see FIGS. 6A-10 and corresponding description below). In some cases, the hydrogen production subsystem 502 includes a reaction vessel that is located externally from a wellbore 302. In such cases, heating may be provided by heated heat transfer fluid 404c. In other cases, the rection vessel may be located within the wellbore 302 at a position that provides an appropriate reaction temperature for thermochemical water splitting, as described in greater detail below (see, e.g., FIGS. 8B and 9B). The vessel may be located at least partially within the magma reservoir 214 to provide this reaction temperature.

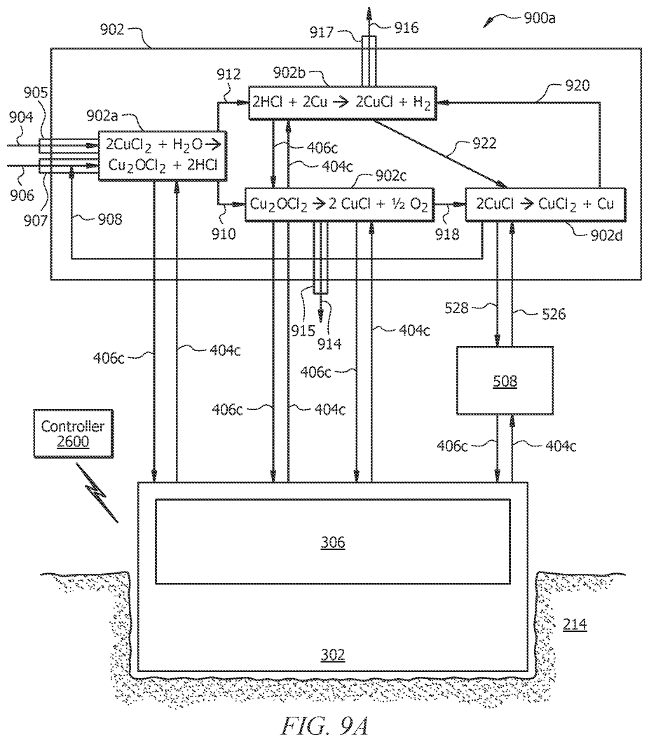

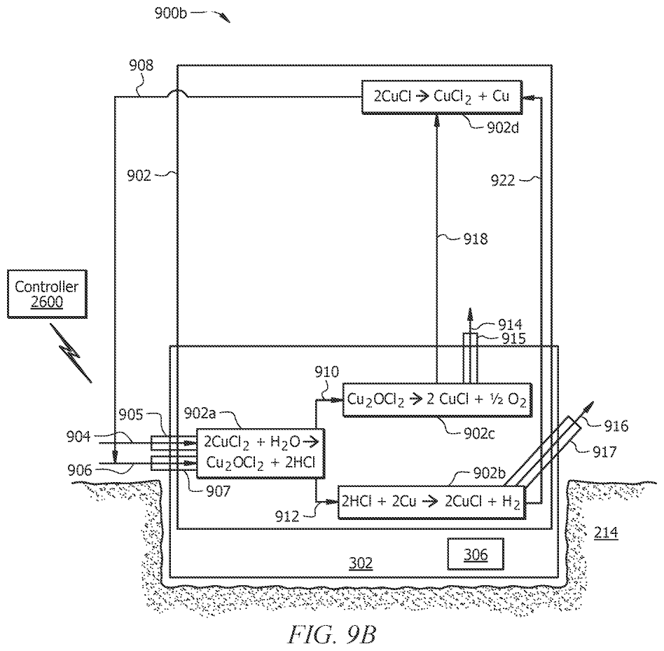

In some cases, the hydrogen production subsystem 502 uses electrolysis to generate hydrogen 514. For example, the hydrogen production subsystem 502 may include an electrolyzer that generates the hydrogen 514 via electrolysis (see the examples of FIGS. 11 and 12). This electrolyzer may be heated by heat transfer fluid 404c and/or the feed stream 510 may be heated using heat transfer fluid 404c. Geothermally generated electricity 408 may be used to drive water splitting by the electrolyzer.

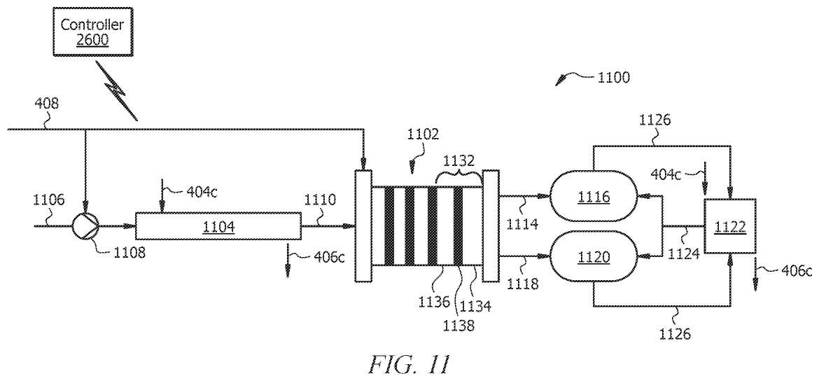

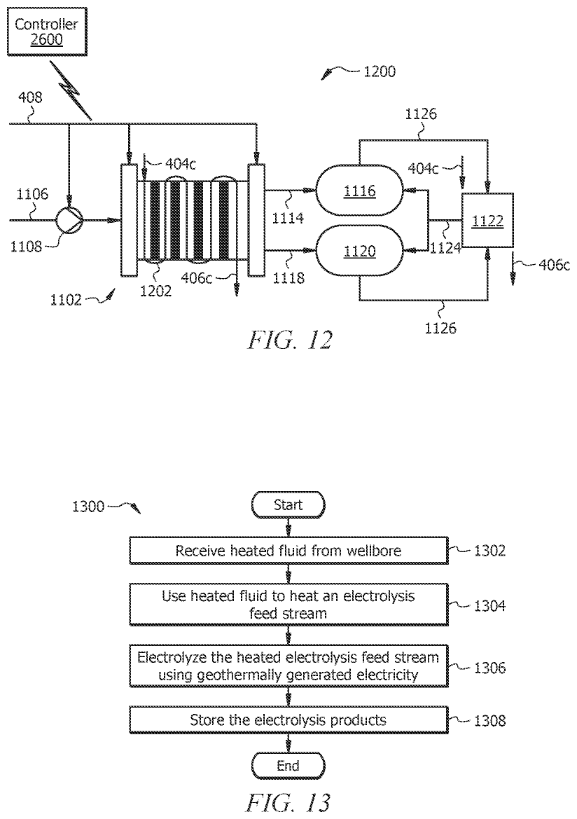

The nitrogen production subsystem 504 receives air 516 and outputs nitrogen 520 and any byproducts 518 of the nitrogen capture/generation process. The air 516 may be ambient air or another stream of air or other nitrogen-containing gas. Byproducts 518 may include oxygen from the air 516. In some embodiments, all or some of the byproducts 518 can be returned to the nitrogen production subsystem 504 in a recycle stream to improve efficiency and/or reduce waste. Further details of example hydrogen generation processes are described in greater detail below with respect to FIGS. 14 and 15. The nitrogen production subsystem 504 may use heat transfer fluid 404c and/or electricity 408 to power nitrogen generation processes (e.g., to separate nitrogen 520 from air 516) and may output cooled heat transfer fluid 406c. As an example, the nitrogen production subsystem 504 may be a pressure swing adsorption system (see FIG. 14 for more details). In such cases, a compressor may compress air 516 using energy obtained from the magma reservoir 214 (e.g., from heat transfer fluid 404c) and nitrogen 520 may be separated from oxygen in this compressed air. As another example, the nitrogen production subsystem 504 may be a fractional distillation system (see FIG. 15 for more details). In such cases, an absorption chiller powered using energy obtained from the magma reservoir 214 may be used to provide at least a portion of the cooling used for the distillation process used to obtain nitrogen 520.

The ammonia production reactor 506 includes a reaction chamber that receives the hydrogen 514 and nitrogen 520 and produces ammonia 522. In some cases, the reaction chamber is positioned inside the wellbore 302. In some cases, the reaction chamber extends into the magma reservoir 214. In other cases, the hydrogen 514 and nitrogen 520 may be heated by heat transfer fluid 404c to a reaction temperature sufficient to cause synthesis of ammonia 522. Electricity 408 may power electrical components of the ammonia production reactor 506.

In some cases, a thermal chiller 508 is employed to facilitate operations of the ammonia production reactor 506 that require cooling. For example, the thermal chiller 508 may use heat transfer fluid 404c to generate a cooling fluid 526 that is provided to the ammonia production reactor 506. The cooling fluid 526 may be used to separate ammonia 522 from other components in the ammonia production reactor 506. A warmed cooling fluid 528 is provided back to the thermal chiller 508 to be cooled and sent back to the ammonia production reactor 506 as cooling fluid 526. The thermal chiller 508 may be an absorption chiller or an adsorption chiller.

In some cases, the ammonia production reactor 506 includes an electrolytic cell that chemically reduces nitrogen 520 to form ammonia 524 (see examples of FIGS. 23A and 23B). In some cases, the electrolytic cell uses both the generated hydrogen 514 and the generated nitrogen 520 (see example of FIG. 23A). However, in other cases, the nitrogen 520 may be reduced without hydrogen 514 (see example of FIG. 23B). An electrolytic cell includes a cathode that reduces the nitrogen 520 to form ammonia 522. A heat exchanger may heat the electrolytic cell using energy obtained from the magma reservoir 214 (e.g., using heat transfer fluid 404c).

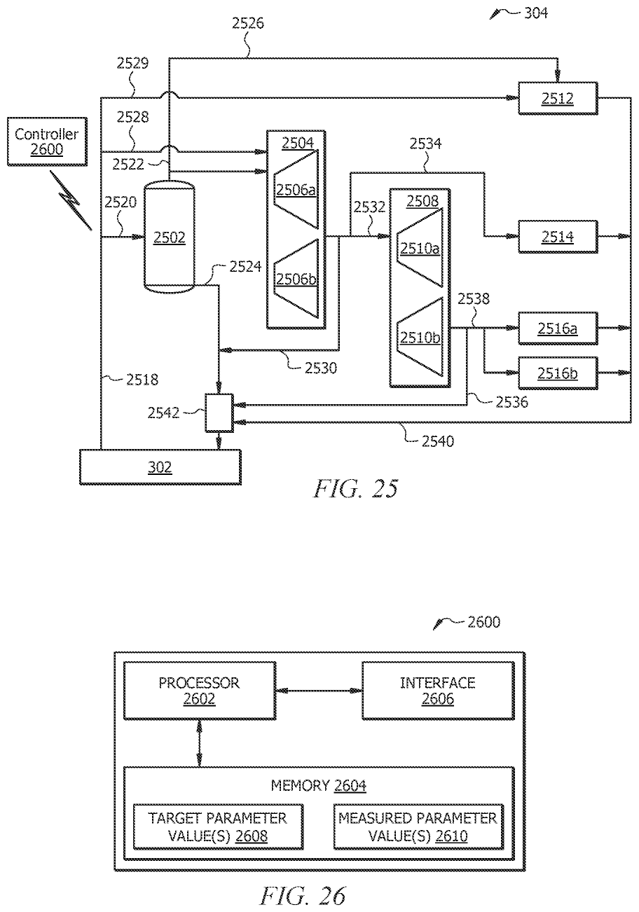

Operations of the geothermally powered ammonia production system 500 may be controlled by a controller 2600. Further details of the structure and operation of examples of the controller 2600 are described with respect to the various examples presented below and in FIG. 26. Further examples of the structures and operations of the hydrogen production subsystem 502, nitrogen production subsystem 504, and ammonia production reactor 506 are provided in the subsections below.

### Example Hydrogen Generation

FIG. 6A is a simplified block diagram of a system 600a for carrying out the thermochemical splitting of water process according to an illustrative example of this disclosure. System 600a may be used as the hydrogen production subsystem 502 of FIG. 5. Operations of system 600a may be controlled at least in part by a controller 2600 (see FIG. 26). Generally, system 600a includes process equipment 602 arranged to convert one or more feed streams 604 (e.g., water) into one or more end product streams 606 (e.g., hydrogen 514) by way of a thermochemical process that uses heat obtained from a subterranean heat source like magma reservoir 214. An optional recycle stream 610 can be fed back into the one or more feed streams 604 to improve efficiency and reduce waste.

The exemplary process equipment 602 depicted in FIG. 6A includes at least a reaction chamber 612. Inlet conduit 605 facilitates input of the one or more feed streams 604 into the process equipment 602, and outlet conduit 607 facilitates flow or removal of product streams 606 from the process equipment 602. Inlet conduit 605 may include one or more valves to control the flow rate of stream 604. The reaction chamber 612 can be the interior volume of a reactor vessel. The reaction chamber 612 can be operated at higher than ambient temperatures and pressures and for conducting thermochemical water splitting. Thermochemical water splitting can be a batch process or a continuous process. The reaction chamber 612 is depicted as a single chamber, but in another embodiment, the reaction chamber 612 can include two or more reaction chambers to permit two or more discrete reactions to occur. The multiple reaction chambers can be housed in a single reactor vessel or separately in multiple reactor vessels.

The process equipment 602 can also include optional recovery equipment 614, which can be used to recover one or more end product streams 606 (e.g., including hydrogen 514 of FIG. 5). Recovery equipment 614 can be any one or more known pieces of equipment, such as a distillation column, condenser, stripping column, extraction tower, or other forms of separator vessel. The condenser may be cooled using water including but not limited to water from an ocean, sea, lake, or river. In addition, the condenser may be driven by steam. The steam may be generated from a geothermal source. The recovery equipment may use heat from a geothermal source (e.g., magma reservoir 214).

For example, a reaction carried out in reaction chamber 612 can produce an intermediate product stream 616 that includes a gaseous end product as well as unreacted reactants in gaseous form. The intermediate product stream 616 can be conveyed to the optional recovery equipment 614 to be separated into one or more end product streams 606 formed entirely from the desired end product, and one or more recycle streams 610 formed from the unreacted reactants. In another example, a reaction carried out in reaction chamber 612 can produce an intermediate product stream 616 that can be separated out into an optional recycle stream 610 and a plurality of different end product streams 606 using conventional separations techniques.

The reaction chamber 612 is heated by heat obtained directly from a subterranean heat source (e.g., magma reservoir 214) accessible by the wellbore 302. The wellbore 302 extends from a surface to an underground location selected to be able to provide the requisite amount of heat to drive reactions within the reaction chamber 612. The reaction temperature is the temperature necessary for a desired thermochemical reaction to occur according to desired parameters. For example, the reaction temperature can be the temperature at which a desired thermochemical reaction can occur within a predetermined time period, at a selected pressure, using a particular catalyst, etc.

In some embodiments, the requisite amount of heat can be obtained simply by drilling to an adequate depth without regard to the presence of subterranean geological formations. In these embodiments, the subterranean heat source is simply the ambient heat that increases as a function of borehole depth.

However, in other embodiments, the subterranean heat source is a magma reservoir 214, and the requisite amount of heat can be obtained by drilling the borehole at a particular location and to a given depth based on the presence or proximity of the magma reservoir 214. As described with respect to FIG. 2 above, a magma reservoir 214 is one or more subterranean geological formations that houses magma. Non-limiting examples of magma reservoir 214 can include sills, laccoliths, lopoliths, diapirs, and plutons. In the example in FIG. 6A, wellbore 302 is drilled so that the terminal end of its borehole is partially within a first magma reservoir 214a, e.g., a pluton, and so that the borehole passes past a second magma reservoir 214b, e.g., a lopolith.

A heat exchanger 306 disposed within the wellbore 302 can harness the heat from the subterranean heat source to provide the reaction chamber 612 with the reaction temperature for carrying out thermochemical water splitting. The heat exchanger 306 can be positioned at the terminal end of the borehole to harness heat from the first magma reservoir 214a or within the borehole at a predetermined depth proximate to the second magma reservoir 214b to harness heat from the magma reservoir 214b. The heat is transferred to a heat transfer fluid 404c that is conveyed to the process equipment 602, e.g., reactor vessel housing the reaction chamber 612, to heat the reaction chamber 612. Spent heat transfer fluid 406c is returned from the process equipment 602 to the heat exchanger 306 and recycled. Heat exchanger 306 may include one or more boilers that pressurize the process equipment 602 using heat from the subterranean heat source (e.g., magma reservoir 214).

The heat transfer fluid 404c, 406c may be any appropriate fluid for absorbing heat obtained from the magma reservoir 214 and driving a thermochemical process as described in this disclosure. For example, the heat transfer fluid 404c, 406c may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). The heat transfer fluid 404c, 406c may be selected at least in part to limit the extent of corrosion of surfaces of various systems described in this disclosure. In some cases, such as to facilitate thermochemical processes requiring higher temperatures than can be achieved using steam or other typical heating fluids, a molten salt may be used as the heat transfer fluid 404c, 406c. A molten salt is a salt that is a liquid at the high operating temperatures required for certain reactors (e.g., at temperatures between 1,600 and 2,300° F.). In some cases, an ionic liquid may be used as the heat transfer fluid 404c, 406c. An ionic liquid is a salt that remains a liquid at more modest temperatures (e.g., at or near room temperature). In some cases, a nanofluid may be used as the heat transfer fluid 404c, 406c. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluid 404c, 406c. For example, molten salts and/or ionic liquids may be stable at the high temperatures that can be reached through heat transfer with magma reservoir 214. The high temperatures that can be achieved by these materials can drive thermochemical processes and/or provide other improvements to performance and/or efficiency that were previously inaccessible using conventional geothermal technology.

The subterranean heat source (e.g., magma reservoir 214) can also provide lower-than-ambient temperatures for the thermochemical process carried out in system 600a by implementation of an optional absorption chiller 508. The absorption chiller 508 can receive a heat transfer fluid 404c from a heat exchanger 306 to form a cooling fluid 526 that can be conveyed to process equipment 602, e.g., to recovery equipment 614. The recovery equipment 614 can be a condenser that can condense a gaseous end product into a liquid phase for separation from unreacted reactants in the gaseous phase. Spent cooling fluid 528 can be returned to the absorption chiller 508 and reused. Spent heat transfer fluid 406c can be returned from the absorption chiller 508 to the heat exchanger 306 and also reused.

Although not depicted in FIG. 6A, a catalyst can be provided to facilitate the thermochemical process. As discussed in more detail with respect to the examples that follow, the catalyst can be located within the reaction chamber 612.

FIG. 6B is a simplified block diagram of another system 600b for conducting thermochemical water splitting processes according to an illustrative example. Operations of system 600b may be controlled at least in part by a controller 2600 (see FIG. 26). System 600b may be used as the hydrogen production subsystem 502 of FIG. 5. Generally, system 600b includes process equipment arranged to convert one or more feed streams 604 into one or more end product streams 606 by way of a thermochemical process that uses heat obtained directly from a subterranean heat source, such as magma reservoir 214, to split water. An optional recycle stream 610 can be fed back into the one or more feed streams 604 to improve efficiency and reduce waste.

System 600b differs from system 600a in that the reaction chamber 612 is located within the wellbore 302 to obtain heat directly from a subterranean heat source, e.g., magma reservoir 214, rather than using heat transfer fluid 404c as a heat source. In system 600b, the reaction chamber 612 can be the interior volume of a reactor vessel that is positioned within the wellbore 302.

In another embodiment, a volume within the wellbore 302 can serve as the reaction chamber 612. In this embodiment, cased or uncased portions of the wellbore 302 can serve as the reaction chamber 612. Heat is provided to the reaction chamber 612 through the sidewalls of the wellbore 302 and through casing segments when present. The reaction chamber 612 can include additional equipment to increase the residence time of the reactants in the reaction chamber 612 or to promote exposure to a catalyst (not shown). For example, the reaction chamber can include a casing plate that at least partially seals an upper end of the reaction chamber 612. The catalyst can be suspended from or otherwise coupled to the casing plate. In addition or in the alternative, the reaction chamber 612 can house a baffle system that promotes mixing and/or increases residence time of reactants in the reaction chamber 612.

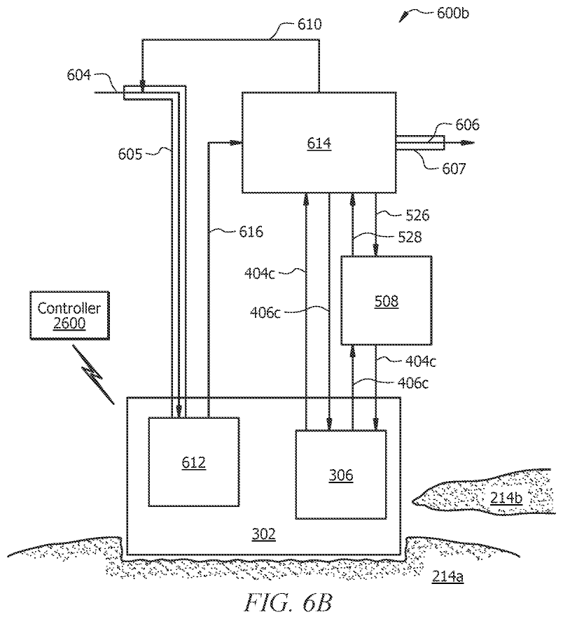

FIG. 7A is a simplified block diagram of another system 700a for thermochemical splitting of water according to an illustrative embodiment. System 700a may be used as the hydrogen production subsystem 502 of FIG. 5. Operations of system 700a may be controlled at least in part by a controller 2600 (see FIG. 26). In thermochemical water splitting reactions, water may be decomposed into hydrogen and oxygen via a series of chemical reactions in which intermediate substances, referred to as catalysts, are cycled between an oxidized and reduced state and the energy needed to drive the reactions is introduced as heat. A simple two-step thermochemical water-splitting reaction to produce hydrogen generally requires very high temperature for endothermic metal oxide reduction to release oxygen and a lower temperature exothermic reaction of water with the metal, increasing the oxidation state of the metal and releasing hydrogen.

The thermochemical splitting of water can occur according to any number of processes, but the exemplary process described in FIG. 7A is described as a metal oxide redox reaction for the sake of simplicity and consistency. General reactions for metal oxide redox reaction for the thermochemical splitting of water includes two steps:

$${M O}_{ox} \to {M O}_{red} + \frac{1}{2} {O}_{2} \qquad REACTION 1$$

$${M O}_{red} + {H}_{2} O \to {M O}_{ox} + {H}_{2} \qquad REACTION 2$$

The first reaction represents an endothermic reaction, and the second reaction represents an exothermic reaction.

Some example classes of reactions for the thermochemical splitting of water are shown in Table 1 below.

TABLE 1
Example reactions

| Reaction class | Chemical Reactions | Temperature (° C.) |
|---|---|---|
| Volatile Metal | CdO(s) → Cd(g) + ½ O₂ (g) | 1450 |
| Oxide | Cd(l, s) + H₂O → CdO(s) + H₂(g) | 25-450 |
| Non-Volatile | NiMnFe₄O₈(s) → NiMnFe₄O₆(s) + O₂(g) | ~1800 |
| Metal Oxide | NiMnFe₄O₆(s) + H₂O(g) → NiMnFe₄O₈(s) + H₂(g) | ~800 |
| Ferrite: | | |
| Non-Volatile | 2a-NaMnO₂(s) + H₂O(l) → Mn₂O₃(s) + 2NaOH(a) | ~100 |
| Metal Oxide | Mn₂O₃(s) → 4 MnO(s) + O₂ (g) | ~100 |
| | 2MnO(s) + 2NaOH → 2a-NaMnO₂(s) + H₂(g) | |
| Sulfuric Acid | 2H₂SO₄(g) → 2SO₂(g) + 2H₂O(g) + O₂(g) | ~850 |
| | I₂ + SO₂(a) + 2H₂O → 2HI(a) + H₂SO₄(a) | ~100 |
| | 2HI → I₂(g) + H₂(g) | ~300 |
| Hybrid Copper | 2CuCl₂ + H₂O → Cu₂OCl₂ + 2HCl | ~400 |
| Chloride | 2Cu₂OCl₂ → O₂ + 4CuCl | ~500 |
| | 2CuCl + 2HCl → 2CuCl₂ + H₂ | ~100 |

In most two-step water-splitting reactions, the temperature for reduction of a metal-oxide intermediate exceeds the vaporization temperature of the metal, such that a vapor-phase metal is created in an initial reaction step. This class of reactions is referred to as the Volatile Metal Oxide class (see Table 1 above). However, some metal oxides can undergo reduction and oxidation without volatilization of the metal. Reactions involving these metal oxides are referred to as Non-Volatile Metal Oxide reactions. Reactions in these two classes generally involve very high temperatures (>1400° C.). In addition to the example metal-oxide catalysts shown in Table 1, suitable catalyst may also include ABO₃-type perovskites such as perovskite BiVO₃.

The non-volatile metal oxide may include copper iron oxide nanocluster, iron-based oxides, ferrites or ferrite-supported zirconia, cerium oxide or cerium-oxide-supported zirconia. The zirconia may be monoclinic zirconia, cubic zirconia, ortetragonal zirconia. Cubic zirconia may be any of yttria, calcia, and magnesia as a stabilizer. The ferrite may be nickel ferrite or nickel-ferrite-supported mono clinic zirconia. The particle sizes of the metal oxide particles may be in a range of 200 to 750 μm. The iron-based oxide may be NiFe₂O₄/m-ZrO₂.

As an alternative to using metal-oxide catalysts, thermal reduction of other chemicals can be used to facilitate water splitting reactions at lower temperatures. An intermediate reaction is typically necessary to release hydrogen, and another reaction (sometimes more than one) is required to restore the oxidation state of the initial compound. These lower temperature reactions generally either employ intermediates for oxidation, complicating the reaction chemistry, or use electrolysis to release hydrogen and restore the original oxidation state of the intermediate substances (catalysts). For example, the sulfuric acid process shown in Table 1 is one of very few low-temperature thermochemical cycles that operate at a moderate temperature (˜850° C.). However, this multi-step process requires an intermediate substance (catalyst) to regenerate the intermediate compound (H₂SO₄ in this example). The sulfuric acid reaction can be achieved through a two-step process by using an electrolytic step to regenerate the intermediate compound. Such electrolytic cycles are referred to as hybrid reactions.

The system 700a includes a reactor vessel 702 that includes a first reaction chamber 702a that accommodates an exothermic reaction of the thermochemical water splitting process and a second reaction chamber 702b that accommodates an endothermic reaction of the thermochemical water splitting process. While the reactor vessel 702 is depicted as a single vessel housing reaction chambers 702a and 702b, in another embodiment the reactor vessel 702 can be formed from two or more separate vessels, each housing one reaction chamber, and located in proximity to one another. Alternatively, the reactor vessel 702 can also be formed from two or more separate vessels located remote from one another, as in the embodiment in which the endothermic reaction of the thermochemical water splitting process is carried out in a wellbore as described in more detail below.

Heat for the endothermic step is provided by a heat exchanger 306 positioned within a wellbore 302, which can harness heat from a subterranean heat source (e.g., magma reservoir 214) as previously described (see, e.g., FIG. 6A). In another embodiment, the second reaction chamber 702b can be located within the wellbore 302 to obviate the need for the underground heat exchanger 306. As previously described with respect to the example of FIG. 6B, the second reaction chamber can be housed within a reactor vessel positioned within the wellbore 302, or the second reaction chamber 702b can be formed from a cased or uncased volume within the wellbore 302 (see, e.g., FIG. 6B).

Still referring to FIG. 7A, a water feed stream 701 is provided to the first reaction chamber 702a via inlet conduit 703 to produce an H₂ product stream 704 and an MOox intermediate product stream 706 that is fed into the second reaction chamber 702b. The second reaction chamber 702b is heated by heat obtained directly from a subterranean heat source (e.g., magma reservoir) to produce an O₂ product stream 708 and an MO_{red} intermediate product stream 710 that is fed back into the first reaction chamber 702a. In some embodiments, the heat provided by the subterranean heat source (e.g., magma reservoir 214) provides the endothermic reaction occurring in the second reaction chamber 702b with a reaction temperature of 1,500° C. or higher, which can be easily achieved when the reaction chamber 702b is located within the wellbore 302. H₂ product stream 704 may exit the reactor vessel 702 via fluid conduit 705, and O₂ product stream 708 may exit the reactor vessel 702 via fluid conduit 709. Conduit 705 may be coupled to the ammonia production reactor 506 (see FIG. 5).

In an example operation of system 700a of FIG. 7A, REACTION 1 occurs in the second reaction chamber 702b to form an oxygen product stream 708 and a reduced intermediate product. REACTION 1 is an endothermic reaction. The heat for the reaction may be obtained from the wellbore 302. The reduced intermediate product stream 710 is fed to the first reaction chamber 702a. A water feed stream is provided to the first reaction chamber 702a. The reaction in reaction chamber 702a proceeds according to REACTION 2 above and produces a hydrogen product stream 704 and an oxidized metal oxide catalyst product stream 706 that is fed to the second reaction chamber 702b. REACTION 2 is an exothermic reaction. Final product streams 708 (oxygen) and 704 (hydrogen) are stored or sent to a downstream process (e.g., to ammonia production reactor 506).

FIG. 7B shows another example system 700b that may be used as the hydrogen production subsystem 502 of FIG. 5. Operations of system 700b may be controlled at least in part by a controller 2600 (see FIG. 26). In system 700b, the reaction chamber 702a is shown housed within the wellbore 302 along with the reaction chamber 702b. The reaction chamber 702a can be placed at a location or depth within the wellbore 302 that is unlikely to expose the reaction chamber 702a to elevated temperatures that could adversely affect the reaction rate of REACTION 2, which is an exothermic reaction. Because temperature within the wellbore 302 generally increases with depth, the reaction chamber 702a can be placed closer to the surface than reaction chamber 702b and/or insulated to protect against exposure to elevated temperatures within the wellbore 302. In another example, the reaction chamber 702a can be housed outside of the wellbore 302 and fluidically coupled with the reaction chamber 702b that is housed within the wellbore 302.

In an example operation of system 700b, REACTION 1 occurs in the second reaction chamber 702b, to form an oxygen product stream 708 and a reduced intermediate product. REACTION 1 is an endothermic reaction. Endothermic reaction chamber 702b is located within a wellbore 302. The reduced intermediate product stream 710 is fed to the first reaction chamber 702a. A water feed stream is provided to the first reaction chamber 702a. The reaction in the first reaction chamber 702a proceeds according to REACTION 2 above and produces a hydrogen product stream 704 and an oxidized metal oxide catalyst product stream 706 that is fed to the second reaction chamber 702b. REACTION 2 is an exothermic reaction. Final product streams 708 (oxygen) and 704 (hydrogen) are stored or sent to a downstream process (e.g., to the ammonia production reactor 506 shown in FIG. 5).

### Iodine-Sulfur Process for Thermochemical Water Splitting

FIG. 8A is a simplified block diagram of a system 800a for thermochemical splitting of water using an iodine-sulfur process. System 800a may be used as the hydrogen production subsystem 502 of FIG. 5. Operations of system 800a may be controlled at least in part by a controller 2600 (see FIG. 26). The system 800a includes a reactor vessel 801 as well as the wellbore 302, the heat exchanger 306, and absorption chiller 508 of FIG. 6A. The reactor vessel 801 includes a first reaction chamber 802a that accommodates an exothermic reaction of the thermochemical splitting process, a second reaction chamber 802b that accommodates an endothermic reaction, and a third chamber 802c that accommodates an endothermic reaction of the thermochemical splitting process. Inlet conduit 805, 807 facilitates input of feed streams 804, 806 into the reactor vessel 801, and outlet conduit 819, 821 facilitates flow or removal of product streams 818, 820 from the reactor vessel 801. Inlet conduit 805, 807 may include one or more valves to control the flow rate of streams 804, 806. The reactor vessel 801 may also include one or more separation chambers 812. In the example of FIG. 8A, the separation chamber 812 separates a product stream 810 from the first reaction chamber 802a into a first product stream 814 that is provided to the second reaction chamber 802b and a second product stream 816 that is provided to the third reaction chamber 802c. While the reactor vessel 801 is depicted as a single vessel housing reaction chambers 802a, 802b, and 802c, in another embodiment, the reactor vessel 801 can be formed from two or more separate vessels, each housing one reaction chamber, and located in proximity to one another.

Alternatively, the reactor vessel 801 can also be formed from two or more separate vessels located remote from one another, as in the embodiment in which the endothermic reaction of the thermochemical splitting process is carried out in the wellbore 302, as described in more detail below with reference to FIG. 8B. The system 800b may facilitate more efficient and effective heating of reactants directly using heat from a subterranean heat source in the second reaction chamber 802b and third reaction chamber 802c to drive endothermic reactions. The subterranean heat source may be a magma reservoir 214.

Referring again to FIG. 8A, in some embodiments, improved cooling of exothermic reactors and separation devices may be achieved using heat from the subterranean heat source (e.g., magma reservoir 214). For example, the absorption chiller 508 may provide cooling with little or no energy from an electrical power grid or another energy source. The subterranean heat source can also provide lower-than-ambient temperatures for the thermochemical process carried out in system 800a by implementation of an absorption chiller 508. The absorption chiller 508 can receive a heat transfer fluid 404c from a heat exchanger 306 to form a cooling fluid 526 that can be conveyed to vessel 801, e.g., to separation chamber 812, reaction chamber 802a, or recovery equipment. The separation chamber 812 may include recovery equipment such as a condenser that can condense a gaseous end product into a liquid phase for separation from unreacted reactants in the gaseous phase. Spent cooling fluid 528 can be returned to the absorption chiller 508 and reused. Spent heat transfer fluid 406c can be returned from the absorption chiller 508 to the heat exchanger 306 for reuse.

As previously mentioned, the thermochemical splitting of water can occur according to a variety of processes, but the exemplary process described in FIG. 8A is a sulfur-iodine reaction. An example sulfur-iodine reaction that can be performed for a water splitting process may include the following steps:

$$2 {H}_{2} O ( l ) + {SO}_{2} ( g ) + {I}_{2} \to {H}_{2} {SO}_{4} ( sol ) + 2 HI ( sol ) \qquad REACTION 3$$

$${H}_{2} {SO}_{4} ( sol ) \to {H}_{2} O ( g ) + {SO}_{2} ( g ) + 1 / 2 {O}_{2} ( g ) \qquad REACTION 4$$

$$2 HI ( sol ) \to {I}_{2} + {H}_{2} ( g ) \qquad REACTION 5$$

The first reaction (REACTION 3) is an exothermic reaction, which can be proceed in the first reaction chamber 802a, while the second and third reactions (REACTIONS 4 and 5) are endothermic reactions, which can proceed in the second reaction chamber 802b and third reaction chamber 802c, respectively.

The products of REACTION 3 include a mixture of sulfuric acid and hydrogen iodide. Carrying out REACTION 3 in the presence of an excess of both sulfur dioxide and iodine, relative to the amount of water available, may result in a two-phase reaction mixture, which can be separated using liquid-liquid separation in separation chamber 812. Alternatively, sulfuric acid and hydriodic acid may be separated by gravimetric separation because the specific gravities of sulfuric acid and hydroiodic acid are sufficiently distinct to permit gravimetric separation. After separation, sulfuric acid may be decomposed to oxygen, sulfur dioxide, and water. In some embodiments, the sulfuric acid may be concentrated to obtain a sulfuric acid product stream.

A water feed stream 804, a sulfur dioxide feed stream 806, an iodine feed stream 808 are provided to the first reaction chamber 802a to produce an intermediate product stream 810 comprising hydrogen iodide and sulfuric acid (see REACTION 3) that is fed into the separating chamber 812. The reaction chamber 802a may be maintained at a suitable temperature. For example, the temperature may be between about 20° C. to about 120° C. The absorption chiller 508 is used to keep the reaction chamber 802a at suitable temperature. The absorption chiller 508 can receive a heat transfer fluid 404c from a heat exchanger 306 to form a cooling fluid 526 that can be conveyed to vessel 801, e.g., to separation chamber 812, reaction chamber 802a, or recovery equipment. The recovery equipment can be a condenser that can condense a gaseous product into a liquid phase for separation from unreacted reactants in the gaseous phase. Spent cooling fluid 528 can be returned to the absorption chiller 508 and reused. Spent heat transfer fluid 406c can be returned from the absorption chiller 508 to the heat exchanger 306 and reused.

The sulfur dioxide feed stream 806 may include sulfur dioxide obtained from a source of sulfur dioxide. The source of sulfur dioxide may be any technically feasible feedstock, such as elementary sulfur or hydrogen sulfide, which are converted to sulfur dioxide. Both elementary sulfur and hydrogen sulfide may be converted to sulfur dioxide by reacting with an appropriate oxidant. The oxidant is preferably oxygen. The sulfur dioxide of the sulfur dioxide feed stream 806 may be obtained through sulfur combustion or as a by-product of a sulfide smelter or roaster, or a SO₂-enrichment step of an industrial process gas cleaning plant. More generally, any other sulfur source, which can be converted to SO₂, may be used to obtain the sulfur dioxide feed stream 806. The sulfide may be copper, nickel, zinc, lead, or iron sulfide.

The iodine feed stream 808 may be elemental iodine. Additionally, iodine may be recycled using recycle stream 824 from the third reaction chamber 802c to the first reaction chamber 802a. The water feed stream 804 may be provided from a municipal water supply or other source of water.

As shown in REACTIONS 3 and 5, hydrogen iodide produced can be isolated in an efficient and practical manner to render it available for decomposition to hydrogen plus iodine. More specifically, the reaction of iodine, sulfur dioxide, and water can be controlled in a manner to yield two liquid phases which are practicably separable from each other. From one of these phases, hydrogen iodide may be derived for use in the third reaction chamber 802c, and from the other phase, sulfuric acid may be derived for use in the second reaction chamber 802b.

The separating chamber 812 may be a liquid-liquid separation system that produces a sulfuric acid intermediate product stream 814 and a hydrogen iodide product stream 816 intermediate product steam that are fed into a second reaction chamber 802b and a third reaction chamber 802c, respectively. Optionally, if required, the separating chamber 812 may be heated by heat obtained directly from a subterranean heat source (e.g., magma reservoir 214) to improve the separation efficiency.

The second reaction chamber 802b may be a decomposition chamber that decomposes sulfuric acid to produce an oxygen product stream 820, sulfur dioxide, and water. The oxygen, sulfur dioxide, and water may be subsequently separated. The sulfur dioxide and water may be recycled back via recycle stream 822 to reaction chamber 802a. Although not shown, optionally, the second reaction chamber 802b may be used to concentrate sulfuric acid and obtain a concentrated sulfuric acid product stream.

The hydrogen iodide intermediate product stream 816 from separating chamber 812 is fed to a third reaction chamber 802c where hydrogen iodide is pyrolyzed resulting in the formation of iodine and hydrogen. The iodine and hydrogen mixture may be subsequently condensed to generate a hydrogen product stream 818 and condensed iodine, which is recycled back to the first reaction chamber 802a. The iodine is recycled back to reaction chamber 802a via recycle stream 824.

In the example of FIG. 8A, heat for the endothermic steps (REACTIONS 4 and 5) may be provided by a heat exchanger 306 positioned within a wellbore 302, which can harness heat from a subterranean heat source (e.g., magma reservoir 214), such as magma reservoir 214, as previously described in FIG. 6A. The heat is harnessed by heat transfer fluid 404c that is conveyed to the reaction chambers 802b and 802c and then recycled back to the heat exchanger 306 for reuse. The spent heat transfer fluid 406c is returned to the heat exchanger 306 for reuse.

In an example operation of system 800a, feed streams 804 and 806 are provided to a first reaction chamber 802a. The reaction proceeds according to REACTION 3 above, while the chamber 802a is cooled to target temperature range using chiller 508. Intermediate product stream 810 is sent to separating chamber 812. Intermediate product streams 814 and 816 comprising sulfuric acid and hydrogen iodide are sent to endothermic reaction chambers 802b and 802c, respectively. In endothermic reaction chamber 802b, the reaction proceeds according to REACTION 4. In endothermic reaction chamber 802c, the reaction proceeds according to REACTION 5. Endothermic reactors are heated by heat exchanger 306. Final product streams 818 and 820 are stored or sent to downstream process (e.g., to ammonia production reactor 506). The reaction system 800a may be maintained at nonambient pressures and/or temperatures, and the resultant yields will depend on these conditions.

In another embodiment shown in FIG. 8B, a modified reaction system 800b has the second and third reaction chambers 802b and 802c located within the wellbore 302 to obviate the need for the underground heat exchanger 306 to provide heat for the endothermic reactions. System 800b may be used as the hydrogen production subsystem 502 of FIG. 5. Operations of system 800b may be controlled at least in part by a controller 2600 (see FIG. 26). Generally, system 800b includes process equipment arranged to convert one or more feed streams 804 and 806 into one or more end product streams 818 and 820 by way of a thermochemical process that uses heat obtained directly from a subterranean heat source (e.g., magma reservoir 214). As previously described in FIG. 6B, the second and third reaction chambers 802b and 802c can be housed within a reactor vessel positioned within the wellbore 302, or the second and third reaction chambers 802b and 802c can be formed from a cased or uncased volume within the wellbore 302. In some embodiments, reaction chambers 802b and 802c may be positioned at a pre-determined depth corresponding to the desired reaction temperature.

In an example operation of system 800b, feed streams 804 and 806 are provided to a first reaction chamber 802a. The reaction proceeds according to REACTION 3 above, while the chamber 802a is cooled to target temperature range using chiller 508. Intermediate product stream 810 is sent to separating chamber 812. Intermediate product streams 814 and 816 comprising sulfuric acid and hydrogen iodide are sent to endothermic reaction chambers 802b and 802c, respectively, located within a wellbore 302. In endothermic reaction chamber 802b, the reaction proceeds according to REACTION 4. In endothermic reaction chamber 802c, the reaction proceeds according to REACTION 5. Endothermic reactors are heated by heat that is transferred to the wellbore 302 from the magma reservoir 214. Final product streams 818 and 820 are stored or sent to downstream process (e.g., to ammonia production reactor 506). The reaction system 800b may be maintained at nonambient pressures and/or temperatures, and the resultant yields will depend on these conditions.

### Copper-Chloride Reaction for Thermochemical Water Splitting

FIG. 9A is a simplified block diagram of another example system 900a for thermochemical splitting of water according to an illustrative embodiment. System 900a may be used as the hydrogen production subsystem 502 of FIG. 5. Operations of system 900a may be controlled at least in part by a controller 2600 (see FIG. 26). The system 900a includes a reactor vessel 902 as well as the wellbore 302, the heat exchanger 306, and absorption chiller 508 (see FIG. 6A). Inlet conduit 905, 907 facilitates input of feed streams 904, 906 into the reactor vessel 902, and outlet conduit 915, 917 facilitates flow or removal of product streams 914, 916 from the reactor vessel 902. Inlet conduit 905, 907 may include one or more valves to control the flow rate of streams 904, 906. The reactor vessel 902 includes a first reaction chamber 902a that accommodates an endothermic reaction of the thermochemical splitting process, a second reaction chamber 902b that accommodates an endothermic reaction of the thermochemical splitting process, a third chamber 902c that accommodates an endothermic reaction of the thermochemical splitting process, and a fourth reaction chamber 902d that accommodates an electrochemical reaction of the thermochemical splitting process. The reactor vessel 902 may also include one or more separation chambers (not shown-see, e.g., separation chamber 812 of FIG. 8A above). While the reactor vessel 902 is depicted as a single vessel housing reaction chambers 902a, 902b, 902c, and 902d, in another embodiment, the reactor vessel 902 can be formed from two or more separate vessels, each housing one reaction chamber, and located in proximity to one another.

Alternatively, the reactor vessel 902 can also be formed from two or more separate vessels located remote from one another, as in the embodiment in which the endothermic reaction of the thermochemical splitting process is carried out in the wellbore 302, as described in more detail below with reference to FIG. 9B. The system 900b facilitates more efficient and effective heating of reactants directly using heat from a subterranean heat source in the first reaction chamber 902a, second reaction chamber 902b, and third reaction chamber 902c to drive endothermic reactions. As described above, the subterranean heat source may be a magma reservoir 214.

Referring again to FIG. 9A, in some embodiments, improved cooling of intermediate product streams and separation devices may be achieved using heat from the subterranean heat source. For example, the absorption chiller 508 may provide cooling with little or no energy from an electrical power grid or another energy source. The subterranean heat source can also provide lower-than-ambient temperatures for the thermochemical process carried out in system 900a by implementation of an absorption chiller 508. The absorption chiller 508 can receive a heat transfer fluid 404c from a heat exchanger 306 to form a cooling fluid 526 that can be conveyed to process vessel 902, e.g., to separation chamber (not shown) or recovery equipment. The separation chamber may include recovery equipment such as a condenser that can condense a gaseous end product into a liquid phase for separation from unreacted reactants in the gaseous phase. Spent cooling fluid 528 can be returned to the absorption chiller 508 and reused. Spent heat transfer fluid 406c can be returned from the absorption chiller 508 to the heat exchanger 306 for reuse.

As previously mentioned, the thermochemical splitting of water can occur according to a variety of processes, but the exemplary process described in FIG. 9A is described as the copper-chlorine (Cu—Cl) process. Thermochemical water splitting with a copper-chlorine (Cu—Cl) process is a promising process that could use heat from subterranean source to decompose water into oxygen and hydrogen through intermediate copper and chlorine compounds.

An example the copper-chlorine process that can be performed for performing a water splitting process may include the following steps:

$$2 {CuCl}_{2} ( s ) + {H}_{2} O ( g ) \to {Cu}_{2} {OCl}_{2} ( s ) + 2 HCl ( g ) \qquad REACTION 6$$

$${Cu}_{2} {OCl}_{2} ( s ) \to 2 CuCl ( l ) + \frac{1}{2} {O}_{2} ( g ) \qquad REACTION 7$$

$$4 CuCl ( s ) \to 2 Cu ( s ) + 2 {CuCl}_{2} ( aq ) \qquad REACTION 8$$

$$2 HCl ( g ) + 2 Cu ( s ) \to 2 CuCl ( s ) + {H}_{2} ( g ) \qquad REACTION 9$$

As shown in REACTIONS 6-9, the Cu—Cl process to split water may comprise a four step process comprising the steps of 1) reacting water and solid copper chloride at a suitable temperature, preferably of about 400° C. to form solid copper chloride oxide (Cu₂OCl₂) and hydrogen chloride gas (REACTION 6); 2) heating Cu₂OCl₂ to a suitable temperature, preferably about 500° C. to about 530° C. to obtain molten copper chloride salt and oxygen gas (REACTION 7); 3) subjecting solid copper chloride to electrolysis at a suitable temperature, preferably of about 20 to about 90° C. to obtain solid copper and an aqueous slurry of copper chloride (REACTION 8); and 4) reacting solid copper and hydrochloric acid gas at a suitable temperature, preferably of about 430° C. to about 475° C. to obtain solid copper chloride and hydrogen gas. The solid copper chloride may be recycled back to step 3 and subjected to the electrolysis step.

The first and second reactions (REACTION 6 and 7) are endothermic reactions, which can proceed in the first and third reaction chambers 902a and 902c, while the third reaction (REACTION 8) is an electrochemical reaction, which can proceed in the fourth reaction chamber 902d. Like the first and second reactions, the fourth reaction (REACTION 9) is an endothermic reaction, which can proceed in the second reaction chamber 902b.

A water feed stream 904 and a copper chloride feed stream 906 are provided to the first reaction chamber 902a to produce two intermediate product streams 910 and 912 comprising copper chloride oxide and hydrochloric acid respectively (see REACTION 6). The reaction chamber 902a may be provided heat from a heat exchanger 306 that obtains heat from a subterranean heat source (e.g., magma reservoir 214). For example, the temperature may be between about 100° C. to about 500° C.

The copper chloride feed stream 906 may include copper chloride obtained from a source of copper chloride and/or copper chloride recycled via stream 908 that may be generated during the thermochemical splitting of water.

The first reaction chamber 902a may be a fluidized bed where steam and solid copper chloride may be fed into the reactor chamber. The steam may be obtained from the wellbore 302 and/or heat transfer fluid 404c. As shown in REACTION 6, copper chloride oxide is a solid and hydrochloric acid a gas. These two intermediate products may be isolated in an efficient and practical manner.

The third reaction chamber 902c may be a decomposition chamber that decomposes copper chloride oxide to produce an oxygen product stream 914 and molten copper chloride stream 918. The second reaction chamber 902b may receive recycled copper via stream 920. Solid Cu may be fed into the second reaction chamber 902b, wherein hydrochloric acid gas from the first reaction chamber 902a reacts with the solid Cu to generate hydrogen gas product stream 916 and solid copper chloride intermediate product stream 922. The solid copper chloride intermediate product stream 922 may be fed into the fourth reaction chamber 902d.

The fourth reaction chamber 902d may be an electrolytic reactor where an electrolysis step may occur generating an aqueous solution of copper (II) chloride and solid copper at an appropriate temperature. The appropriate temperature may be maintained by implementation of an absorption chiller 508. The absorption chiller 508 can receive a heat transfer fluid 404c from a heat exchanger 306 to form a cooling fluid 526 that can be conveyed to vessel 902, e.g., to separation chamber (not shown) or recovery equipment.

Heat for the endothermic steps (REACTIONS 6, 7 and 9) may be provided by a heat exchanger 306 positioned within a wellbore 302, which can harness heat from a subterranean heat source, such as magma reservoir 214, as previously described in FIG. 6A. The heat is harnessed by heat transfer fluid 404c that is conveyed to the reaction chambers 802b and 802c and then recycled back to the heat exchanger 306 for reuse. The spent heat transfer fluid 406c is returned to the heat exchanger 306 for reuse.

In an example operation of system 900a of FIG. 9A, feed streams 904 and 906 are provided to a first reaction chamber 902a. The first reaction chamber is an endothermic reactor and may be a fluidized bed. The reaction proceeds according to REACTION 6 above. Intermediate solid product stream 910 (copper chloride oxide) and intermediate gas product stream 912 (hydrochloric acid) are sent to the endothermic second reaction chamber 902b and endothermic third reactor chambers 902c. In endothermic reaction chamber 902b, the reaction proceeds according to REACTION 9. In endothermic reaction chamber 902c, the reaction proceeds according to REACTION 7. Endothermic reactors are heated by heat exchanger 306. Intermediate product stream 918 (liquid copper chloride) is cooled using the absorption chiller 508 (not shown) to generate solid copper chloride that is fed into the fourth reaction chamber 902d, where an electrochemical reaction proceeds according to REACTION 8. Final product streams 914 (oxygen) and 916 (hydrogen) are stored or sent to downstream process (e.g., to ammonia production reactor 506).

In another embodiment shown in FIG. 9B, a modified reaction system 900b has the first, second, and third reaction chambers 902a, 902b and 902c located within the wellbore 302 to obviate the need for the underground heat exchanger 306 to provide heat to drive the endothermic reactions. System 900b may be used as the hydrogen production subsystem 502 of FIG. 5. Operations of system 900b may be controlled at least in part by a controller 2600 (see FIG. 26). Generally, system 900b includes process equipment arranged to convert one or more feed streams 904 and 906 into one or more end product streams 914 and 916 by way of a thermochemical process that uses heat obtained directly from a subterranean heat source, such as a magma reservoir 214. As previously described in FIG. 6B, the first, second, and third reaction chambers 902a, 902b, and 902c can be housed within a reactor vessel positioned within the wellbore 302, or the first, second, and third reaction chambers 902a, 902b and 902c can be formed from a cased or uncased volume within the wellbore 302. In some embodiments, reaction chambers 902a, 902b and 902c may be positioned at a pre-determined depth corresponding to the desired reaction temperature. The reaction systems 900a and 900b may be maintained at nonambient pressures and/or temperatures, and the resultant yields will depend on these conditions.

In an example operation of system 900b of FIG. 9B, feed streams 904 and 906 are provided to a first reaction chamber 902a. The first reaction chamber is an endothermic reactor and may be a fluidized bed. The reaction proceeds according to REACTION 6 above. Intermediate solid product stream 910 (copper chloride oxide) and intermediate gas product stream 912 (hydrochloric acid) are sent to the endothermic second reaction chamber 902b and endothermic third reactor chambers 902c. In endothermic reaction chamber 902b, the reaction proceeds according to REACTION 9. In endothermic reaction chamber 902c, the reaction proceeds according to REACTION 7. Endothermic reaction chambers 902a, 902b, and 902c are located within a wellbore 302 and heated by heat transferred to the wellbore 302 from the magma reservoir 214. Intermediate product streams 918 and/or 922 (liquid copper chloride) can be cooled using the absorption chiller 508 (not shown) to generate solid copper chloride that is fed into the fourth reaction chamber 902d, where an electrochemical reaction proceeds according to REACTION 8. Final product streams 914 (oxygen) and 916 (hydrogen) are stored or sent to downstream process (e.g., to ammonia production reactor 506).

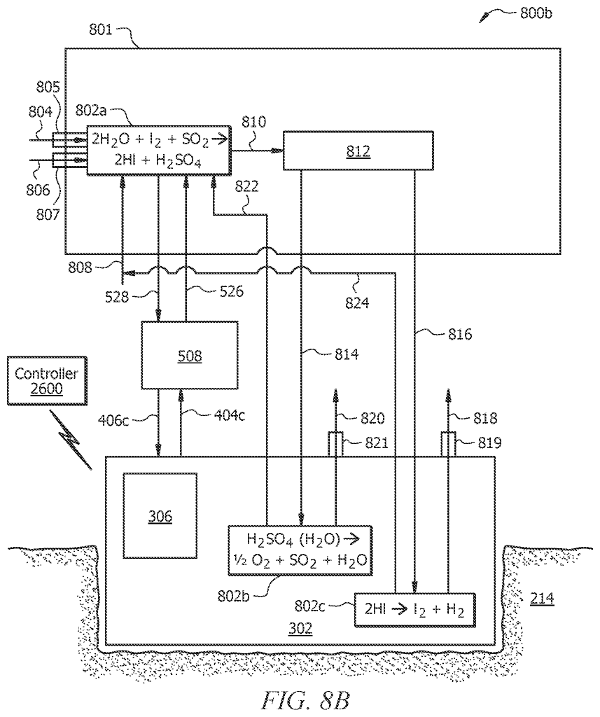

FIG. 10 is an example method 1000 of thermochemical water splitting using the systems of this disclosure (e.g., systems of FIGS. 6A-9B). The method 1000 may begin at step 1002 where water is contacted with a catalyst (see, e.g., the examples of Table 1 above). At step 1004, the water and catalyst are heated using energy obtained from the magma reservoir 214. This heating results in thermochemical water splitting. At step 1006, the hydrogen and oxygen obtained from thermochemical water splitting are separated. At step 1008, the hydrogen is stored or sent to the ammonia production reactor (e.g., reactor 506 of FIG. 5) for use in generating ammonia.

Modifications, omissions, or additions may be made to method 1000 depicted in FIG. 10. Method 1000 may include more, fewer, or other steps. For example, at least certain steps may be performed in parallel or in any suitable order. All or a portion of the operations may be performed by the systems of FIGS. 6A-9B and may be facilitated using the controller 2600 (see also FIG. 26).

### Geothermally Mediated Electrolysis

Hydrogen can also be obtained through the electrolysis of water. Previous technology aiming to improve water electrolysis primarily focuses on the use of solar power for driving electrolytic hydrogen production. While this approach utilizes renewable energy, it suffers from drawbacks in its reliability and overall effectiveness. Solar energy is only intermittently available based on time of day and weather, resulting in considerable amounts of time during which solar-powered electrolysis cannot be performed. Furthermore, the efficiency of these processes (e.g., amount of hydrogen obtained per unit of solar energy) is relatively low, such that solar-generated hydrogen is not viable when compared to other fuels that can be obtained at lower costs. This disclosure recognizes these shortcomings of previous technologies and provides solutions in the form of more resilient and efficient approaches to hydrogen generation via the geothermally heated electrolysis systems described below. In these example systems, a geothermal system harnesses heat from a geothermal resource with a sufficiently high temperature that can be used to both reliably power the electrolysis process (e.g., by providing an electrical current) and to heat the process to temperature conditions (e.g., superheated conditions) that not only decreases electrical energy demands but also improves overall reaction efficiency. Solar and wind energy also cannot reliably and efficiently provide the heating-based improvements of this disclosure. For example, solar energy is only intermittently available to provide direct solar heating, and wind power can only indirectly provide heating by using wind-derived electricity to power an electric heater. Thus, these energy sources are not only relatively unreliable but are less efficient because of the need to convert the energy source to electricity (with associated energy losses) and then use the electricity to heat the electrolysis fluid (with additional associated energy losses).

FIG. 11 shows an example geothermally powered hydrogen production system 1100 that may be used as the hydrogen production subsystem 502 of FIG. 5. Operations of system 1100 may be controlled at least in part by a controller 2600 (see FIG. 26). The configuration of FIG. 11 is provided as an example only. The geothermally powered hydrogen production system 1100 may include more or fewer components, and the components may be arranged in different configurations in order to produce hydrogen (see stream 1118). Operations of the geothermally powered hydrogen production system 1100 may be powered at least partially by geothermal energy from the heat transfer fluid 404c (e.g., steam), which obtained its heat from the magma reservoir 214 via the stream of heat transfer fluid 404a. For example, the heat transfer fluid 404c (or a secondary heat transfer fluid heated by heat transfer fluid 404c) may be used to heat components of the geothermally powered hydrogen production system 1100 or may be converted to mechanical or electrical energy to perform operations in the geothermally powered hydrogen production system 1100, as described further below.

The geothermally powered hydrogen production system 1100 is configured to preheat an electrolysis feed stream 1106 that is provided to an electrolyzer 1102. The geothermally powered hydrogen production system 1100 includes the electrolyzer 1102, a heat exchanger 1104, a fluid pump 1108, an oxygen storage tank 1116, a hydrogen storage tank 1120, and an absorption chiller 1122 (optional). The electrolyzer 1102 is configured, when powered by electricity 408, to convert water to hydrogen and oxygen via the reaction 2H₂O→2H₂+O₂. The electrolyzer 1102 may be any appropriate type of electrolyzer, such as an alkaline water electrolyzer, a proton exchange membrane (PEM) electrolyzer, a steam electrolyzer, or the like. In operation, heated electrolysis feed stream 1110 enters the electrolyzer 1102. The heated electrolysis feed stream 1110 may be steam or high temperature water (e.g., heated by the heat exchanger 1104, as described below). The electrolyzer 1102 may facilitate the electrolysis of steam. The electrolyzer 1102 may be maintained at an increased pressure to facilitate high-temperature and high-pressure electrolysis of liquid water. The electrolyzer 1102 may be insulated and/or heated (see, e.g., example of FIG. 12 showing a heated electrolyzer).

Electricity 408 is used to apply a voltage across one or more electrolytic cells 1132 of the electrolyzer 1102. In the example of FIG. 11, the electrolyzer includes multiple cells 1132. Each cell 1132 includes an anode 1134, a cathode 1136, and a separator 1138. The anode 1134 and cathode 1136 are generally pieces of metal, alloy, or other conductive material (e.g., a carbon-based material) with optionally one or more catalysts deposited thereon. The separator 1138 may be an electrolyte, a membrane, or a combination of these. For example, a cell 1132 in a PEM electrolyzer may include an anode 1134 and cathode 1136 with a PEM positioned between the anode 1134 and cathode 1136 as the separator 1138. During an example operation of such a PEM cell, oxygen is generated on the anode side of the PEM separator 1138, and hydrogen is generated at the cathode side of the PEM separator 1138.

The heat exchanger 1104 uses heat from the heated heat transfer fluid 404c (see FIG. 4) to increase the temperature of the electrolysis feed stream 1106. The heat exchanger 1104 may be any appropriate type of heat exchanger. Examples of the heat exchanger 1104 include shell-and-tube or tube-in-tube type heat exchangers. The heated heat transfer fluid 404c may be used directly to heat the electrolysis feed stream 1106 (as shown in the example of FIG. 11), or the heated heat transfer fluid 404c may heat a secondary heat transfer fluid that is then provided to the heat exchanger 1104. The secondary heat transfer fluid may be any similarly suitable fluid as chosen for the heat transfer fluid 404c.

The oxygen storage tank 1116 is any vessel capable of safely storing oxygen generated by the electrolyzer 1102. In some cases, oxygen may not be collected. Instead, oxygen may be released into the atmosphere. In some cases, rather than storing generated oxygen in a tank 1116, the oxygen may be provided to a downstream process for use (e.g., to support a chemical process requiring oxygen). Similarly, the hydrogen storage tank 1120 is any vessel capable of safely storing hydrogen generated by the electrolyzer 1102. In some cases, the hydrogen is provided directly to a downstream process (e.g., to ammonia production reactor 506 of FIG. 5).

The example geothermally powered hydrogen production system 1100 includes an absorption chiller 1122. The absorption chiller 1122 uses geothermal energy from the heated heat transfer fluid 404c to provide cooling to components of the geothermally powered hydrogen production system 1100. This approach to cooling improves efficiency, for example, because a separate energy source is not needed to provide cooling. In the example of FIG. 11, the absorption chiller 1122 provides cooling to the oxygen storage tank 1116 and the hydrogen storage tank 1120. The absorption chiller 1122 receives the heated heat transfer fluid 404c and generates a cooling fluid provided in cooling fluid streams 1124 to the storage tanks 1116, 1120. The streams 1124 cool the tanks 1116, 1120 (e.g., by passing through a heat exchanger wrapped around or otherwise in contact with the tanks 1116, 1120). A warmed cooling fluid is generated in this process and provided back to the absorption chiller 1122 via fluid streams 1126. The cooling fluid may be water, a refrigerant, or any other appropriate fluid for cooling the tanks 1116, 1120 and/or other components of the geothermally powered hydrogen production system 1100. While shown cooling the tanks 1116, 1120, the absorption chiller 1122 may cool more or fewer components of the geothermally powered hydrogen production system 1100.

In an example operation of the geothermally powered hydrogen production system 1100, an electrolysis feed stream 1106 is pumped toward the heat exchanger 1104 using fluid pump 1108. The electrolysis feed stream 1106 may be water. The electrolysis feed stream 1106 may be purified or ultra-pure water. The electrolysis feed stream 1106 may include one or more electrolytes or other components to facilitate electrolysis. For example, the electrolysis feed stream 1106 may be an alkaline solution (e.g., a KOH solution). The fluid pump 1108 may be powered by electricity 408 that is geothermally generated. Electricity demand may be decreased by heating the electrolysis feed stream 1106.

The electrolysis feed stream 1106 enters the heat exchanger 1104 and is heated by the heated heat transfer fluid 404c. A heated electrolysis feed stream 1110 from the heat exchanger 1104 enters the electrolyzer 1102. The heated electrolysis feed stream 1110 may be steam, high temperature water, superheated water (i.e., liquid water above its boiling point at the current pressure), superheated steam (i.e., steam at a temperature greater than the boiling point of water at the current pressure), or a mixture of these. The heated electrolysis feed stream 1110 may be pressurized to maintain the heated electrolysis feed stream 1110 in the liquid phase. The electrolyzer 1102 causes the water to be split to form hydrogen and oxygen, as described above. By performing electrolysis at an increased temperature, the amount of electricity 408 needed to drive the water-splitting process may be decreased. This disclosure also recognizes that preheating the electrolysis feed stream 1106 may provide unexpected improvements to the overall efficiency of the electrolysis process.

An oxygen stream 1114 that includes oxygen generated in the electrolyzer 1102 exits the electrolyzer 1102 and is stored in the oxygen storage tank 1116. A hydrogen stream 1118 that includes hydrogen generated in electrolyzer 1102 exits the electrolyzer 1102 and is stored in the hydrogen storage tank 1120. The absorption chiller 1122 may provide cooling to maintain the storage tanks 1116, 1120 at appropriately cool temperatures for safe storage of oxygen and hydrogen. Although not illustrated for conciseness, the geothermally generated electricity 408 may also power other components used for oxygen and/or hydrogen purification and storage. For example, electricity 408 may be used at least in part to power cryogenic processes for liquefaction of the oxygen and/or hydrogen. Such processes may be aided by the absorption chiller 1122.

FIG. 12 shows another example geothermally powered hydrogen production system 1200 that may be used as the hydrogen production subsystem 502 of FIG. 5. Operations of system 1200 may be controlled at least in part by a controller 2600 (see FIG. 26). The example geothermally powered hydrogen production system 1200 includes the same or similar components to those described above with respect to FIG. 11. The geothermally powered hydrogen production system 1200 of FIG. 12 also includes a heat exchanger 1202 that heats the electrolyzer 1102. The heat exchanger 1202 may be a coil heat exchanger that is wrapped around the electrolyzer 1102 and/or that passes through an interior of the electrolyzer 1102. For example, one or more coils of the heat exchanger 1202 may pass along the surface and/or through an internal volume of the electrolyzer 1102. Heated heat transfer fluid 404c flowing through the heat exchanger 1202 heats the electrolyzer 1102 to increase the temperature of the electrolysis process. The geothermally powered hydrogen production system 1200 could also include the heat exchanger 1104 of FIG. 11 (not shown for conciseness) to preheat the electrolysis feed stream 1106 before it enters the heated electrolyzer 1102 with heat exchanger 1202.

In an example operation of the geothermally powered hydrogen production system 1200, an electrolysis feed stream 1106 is pumped toward the electrolyzer 1102 using fluid pump 1108. The electrolysis feed stream 1106 enters the electrolyzer 1102 where it is heated by the heated heat transfer fluid 404c via heat exchanger 1202. Water in the electrolysis feed stream 1106 is electrolytically split to form hydrogen and oxygen, as described above. By performing electrolysis at an increased temperature in the heated electrolyzer 1102 with heat exchanger 1202, the amount of electricity 408 needed to drive the water-splitting process may be decreased and overall reaction efficiency may be improved. As described above with respect to the example operation of the system 1100 of FIG. 11, an oxygen stream 1114 that includes oxygen generated in the electrolyzer 1102 exits the heated electrolyzer 1102 and is stored in the oxygen storage tank 1116. A hydrogen stream 1118 that includes hydrogen generated in the heated electrolyzer 1102 exits the electrolyzer 1102 and is stored in the hydrogen storage tank 1120 (or sent directly to ammonia production reactor 506). The absorption chiller 1122 may provide cooling to maintain the storage tanks 1116, 1120 appropriately cool temperatures for safe storage of oxygen and hydrogen.

### Example Method of Geothermally Powered Hydrogen Production

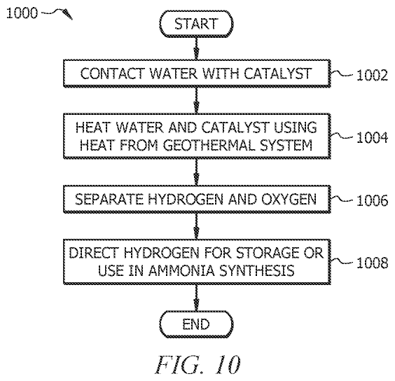

FIG. 13 shows an example method 1300 of operating the geothermally powered hydrogen production systems 1100 and 1200 of FIGS. 11 and 12. The method 1300 may begin at step 1302 where heated heat transfer fluid 404c is received. The heated heat transfer fluid 404c may include fluid output by the thermal process system 304 and/or heat transfer fluid 404a received directly from the wellbore 302 (see FIG. 4). At step 1304, the heated heat transfer fluid 404c is used to heat the electrolysis feed stream 1106 (see FIG. 11). At step 1306, the heated electrolysis feed stream 1110 is electrolyzed by the electrolyzer 1102 using electricity 408 generated using geothermal energy (see FIG. 11). This process results in the formation of hydrogen and oxygen. At step 1308, the electrolysis products are stored. For example, hydrogen may be stored in the hydrogen storage tank 1120. In some cases, hydrogen is sent directly to the ammonia production reactor 506 of FIG. 5.

Modifications, omissions, or additions may be made to method 1300 depicted in FIG. 13. Method 1300 may include more, fewer, or other steps. For example, at least certain steps may be performed in parallel or in any suitable order. While at times discussed as geothermally powered hydrogen production systems 1100, 1200 performing steps, any suitable component or components of the geothermally powered hydrogen production systems 1100, 1200 or other components used for geothermal and/or electrolytic processes may perform or may be used to perform one or more steps of the method 1300. All or a portion of the operations may be performed by or facilitated using information determined using the controller 2600 (see also FIG. 26).

### Example Nitrogen Generation

FIG. 14 is an example geothermally powered pressure swing adsorption system 1400 that may be used as the nitrogen production subsystem 504 of FIG. 5. The geothermally powered pressure swing adsorption system 1400 separates nitrogen (i.e., nitrogen 520 of FIG. 5) from air (i.e., air 516 of FIG. 5) using a pressure swing adsorption process. During this process, one tank (e.g., 1402a) is pressurized to collect compressed air, while the other tank (e.g., 1402b) is de-pressurized to release collected nitrogen. The geothermally powered pressure swing adsorption system 1400 includes the tanks 1402a,b with corresponding adsorbents 1404a,b, a first compressor 1406, valves 1408a,b, 1410a,b, 1412,a,b, a regeneration compressor 1414, conduits 1416, and the controller 2600.

Tanks 1402a,b, are any vessels capable of storing compressed air and accommodating adsorbents 1404a,b. Adsorbents 1404a,b may be a material that binds with oxygen, water vapor, and other non-nitrogen components of the compressed. As an example, an adsorbent 1404a,b may be a carbon molecular sieve that separates oxygen from nitrogen in the tank 1402a,b. The carbon molecular sieve traps oxygen molecules while allowing nitrogen molecules to escape when gas is initially released from the tank 1402a,b.

The compressors 1406, 1414 are generally any type of compressors capable of increasing the pressure of fluid (e.g., air or components of air) passing therethrough. In some cases, one or both of the compressors 1406, 1414 are powered by geothermal energy. For example, one or both of the compressors 1406, 1414 may be powered using electricity 408. As another example, one or both of the compressors 1406, 1414 may include a thermally powered motor that is powered by heated heat transfer fluid 404c. For example, if heat transfer fluid 404c is steam (or used to generate steam), this steam may be used to impart motion to the thermally powered motor of the compressor(s) 1406, 1414. For example, the thermally powered motor may include a piston within a cylinder along with valve(s) to control introduction of steam into the cylinder, such that the piston moves within the cylinder. A rod connected to the piston moves along within the piston and imparts motion to a flywheel. The flywheel is in turn coupled to movable components of the compressor(s) 1406, 1414, such as a rotor or a blower. Further details of an example thermally powered motor are described in U.S. Provisional Patent Application No. 63/448,929, filed Feb. 28, 2023, and titled “Drilling equipment powered by geothermal energy”, the entirety of which is hereby incorporated by reference.

Valves 1408a,b, 1410a,b, 1412,a,b are generally electromechanical valves, such as ball valves, that can be opened and closed by controller 2600 to obtain the various configurations used to perform pressure swing adsorption. For example, a control signal provided from controller 2600 may cause valves 1408a,b, 1410a,b, 1412,a,b to open or close to achieve the various configurations described with respect to the example operation of the geothermally powered pressure swing adsorption system 1400 below.

During an example operation of the geothermally powered pressure swing adsorption system 1400, the first compressor 1406 compresses the air and causes the air to flow into the tank 1402a,b that is currently active for nitrogen separation. Valves 1408a,b and 1410a,b control flow of the compressed air into the tank 1406a,b via conduit 1416. For example, when the first tank 1402a is collecting compressed air, valve 1408a is open and valve 1410a is closed. This allows the compressed air to flow into the tank 1402a. Meanwhile, valve 1408b is closed to prevent air from entering the conduit 1416 leading to the second tank 1402b. Initially, valve 1412b is opened to release nitrogen from the second tank 1402b, while valve 1410b is closed. After a period of time, valve 1412b is closed and valve 1410b is opened to regenerate adsorbent 1404b. Secondary compressor 1414 may be powered on to aid in removing components (e.g., oxygen, water vapor, etc.) trapped by the adsorbent 1404b. This regenerates the adsorbent 1404b for another round of nitrogen generation in the second tank 1402b. In some cases, heat from the wellbore 302 (e.g., from heated heat transfer fluid 404c) may be used to improve regeneration of the adsorbent 1404b. for example, the absorbent 1404c may be depressurized to release trapped oxygen, water vapor, and the like, while the absorbent is simultaneously heated by heated heat transfer fluid 404c to aid the removal of these species. This approach may improve performance of the adsorbent 1404b over time and efficiency of the overall nitrogen collection process.

After the first tank 1402a is filled to a predetermined capacity or pressure, the various valves 1408a,b, 1410a,b, 1412,a,b are adjusted to release nitrogen from the first tank 1402a (e.g., opening valve 1412a and closing valve 1408a) and begin collecting nitrogen in the second tank 1402b (e.g., opening valve 1408b and closing valve 1410b). These processes are repeated to continue generating nitrogen that may be provided to the ammonia production reactor 506 of FIG. 5.

FIG. 15 is an example geothermally powered distillation system 1500 that may be used as the nitrogen production subsystem 504 of FIG. 5. The geothermally powered distillation system 1500 separates nitrogen 1530 (i.e., corresponding to nitrogen 520 of FIG. 5) from air 1502 (i.e., corresponding to air 516 of FIG. 5) using a distillation process. During this process, air 1502 is compressed and liquified using geothermally powered cooling. Components of the liquified air are then separated using a distillation column 1524 to obtain nitrogen 1530 that may be provided to the ammonia production reactor 506 of FIG. 5. The geothermally powered distillation system 1500 includes a compressor 1504, an air cooler 1508, a heat-driven chiller 1512, expansion device 1518, an optional storage vessel 1522, the distillation column 1524, a heat exchanger 1526, and the controller 2600.

The compressor 1504 compresses air 1502 to form compressed air 1506. Compressor 1504 is generally any type of compressor capable of increasing the pressure of air 1502 to form compressed air 1506. In some cases, compressor 1504 is powered by geothermal energy. For example, compressor 1504 may be powered using electricity 408. As another example, compressor 1504 may include a thermally powered motor that is powered by heated heat transfer fluid 404c, as described above with respect to the example compressors 1406, 1414 of FIG. 14. For example, if heat transfer fluid 404c is steam (or used to generate steam), this steam may be used to impart motion to the thermally powered motor of the compressor 1504. For example, the thermally powered motor may include a piston within a cylinder along with valve(s) to control introduction of steam into the cylinder, such that the piston moves within the cylinder. A rod connected to the piston moves along within the piston and imparts motion to a flywheel. The flywheel is in turn coupled to movable components of the compressor 1504, such as a rotor or a blower. Further details of an example thermally powered motor are described in U.S. Provisional Patent Application No. 63/448,929, which is already incorporated herein by reference.

The air cooler 1508 cools the compressed air 1506. The air cooler 1508 uses a cooling fluid 1510 to cool the compressed air 1506. A heat-driven chiller 1512, such as an absorption chiller, generates the cooling fluid 1510 using the heat transfer fluid 404c as the heat source in the absorption refrigeration cycle. The cooling fluid 1510 is provided to the air cooler 1508. Warmed cooling fluid 1514 is returned to the heat-driven chiller 1512 to be cooled again. Cooled, compressed air 1516 is output by the air cooler 1508 and provided to the expansion device 1518. The expansion device 1518 may be an expansion valve that removes pressure from the cooled, compressed air 1516 to aid in forming liquified air 1520 that is provided to the distillation column 1524.

The distillation column 1524 separates components of the liquified air 1520 based on their boiling points. Nitrogen 1530 exits as a gas from the top of the distillation column 1524 while liquid oxygen 1528 exits the bottom of the distillation column 1524. The nitrogen 1530 can be used as nitrogen 520 of FIG. 5 for ammonia production.

### Example Ammonia Generation

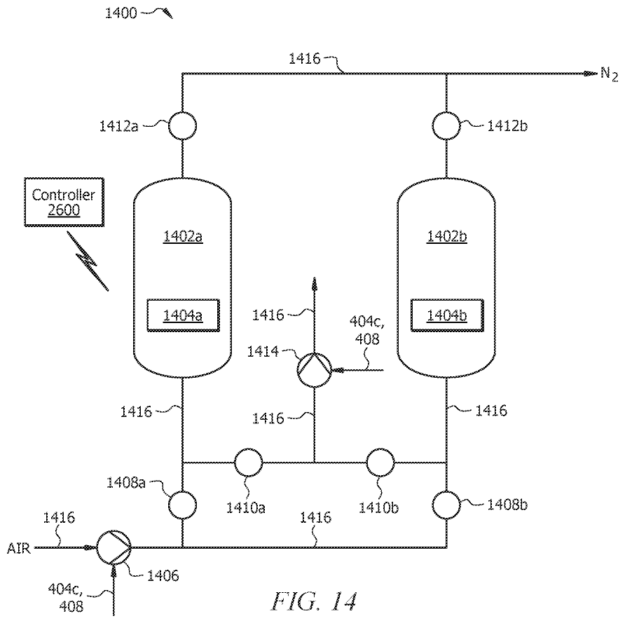

FIG. 16 is a schematic diagram of a first system 1600 for forming ammonia from one or more feed streams comprised of N₂ and H₂. The system 1600 may be used as the ammonia production reactor 506 of FIG. 5. Operations of 1600 may be controlled at least in part by controller 2600 (see FIG. 26). The received N₂ may be nitrogen 520, and the received H₂ may be hydrogen 514. The formed ammonia may be ammonia 522 of FIG. 5. The ammonia can be formed in a reaction chamber 1616 that is disposed within a wellbore 302 so that reaction chamber 1616 can be heated directly by a subterranean heat source. In system 1600, the reaction chamber 1616 is an uncased portion of the wellbore 302 that obtains heat from magma reservoir 214.

In this illustrative embodiment, the reaction chamber 1616 is sealed at its upper end by a casing plate 1602 that spans the diameter of the wellbore 302. One or more feed stream conduits 1604 extends between one or more reactant sources (not shown) that form the feed stream and the reaction chamber 1616. The one or more feed stream conduits 1604 can pass through the casing plate 1602 and extend into reaction chamber 1616 to a predetermined depth. Exposure of the reactants to heat obtained directly from a subterranean heat source, e.g., magma reservoir 214, and catalyst 1606 causes at least some of the reactants to form an intermediate product stream that is carried out of the reaction chamber 1616 via one or more intermediate product stream conduits 1608.

The intermediate product stream is conveyed into recovery equipment 1618, which includes a condenser in the example system 1600 depicted in FIG. 16. More generally, recovery equipment 1618 can be any one or more known pieces of equipment, such as a distillation column, condenser, stripping column, extraction tower, or other forms of separator vessel. The recovery equipment 1618 separates the intermediate product stream into an unreacted reactant fraction that is fed back into the reaction chamber 1616 via recycle stream conduit 1612, and a liquid phase end product fraction 1610 that is extracted from the recovery equipment 1618 by end product stream conduit 1614. When system 1600 is configured to produce ammonia by the Haber Bosch process, the feed stream includes N₂ and H₂ that is converted into an NH₃ end product according to the following equation: N₂+3H₂→2NH₃.

In this illustrative embodiment, the catalyst 1606 is depicted as generally suspended from the casing plate 1602. In a particular example of this embodiment, the casing plate 1602 can be configured with a series of baffles (not shown) coupled to the casing plate 1602 and having external surfaces coated with a layer of catalyst 1606. In another particular example of this embodiment, the casing plate can include a plurality of elongated members extending towards the terminal end of the borehole, each of which includes an external surface coated with a layer of catalyst 1606.

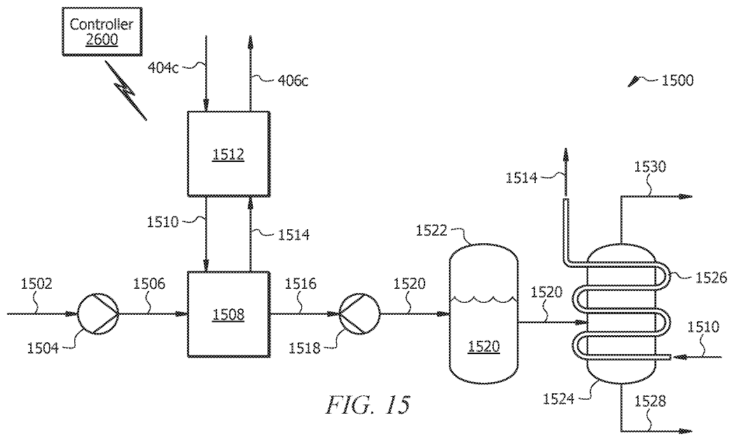

FIG. 17 is a schematic diagram of a second system 1700 for forming ammonia according to another illustrative embodiment. System 1700 may be used as the ammonia production reactor 506 of FIG. 5. The system 1700 is similar to the system 1600 of FIG. 16 except that the catalyst 1606 is applied to the surfaces of the one or more feed stream conduits 1604 and/or the one or more intermediate product stream conduits 1608. As an example, the catalyst 1606 is shown applied to the inner and outer surfaces of the one or more feed stream conduits 1604, and the catalyst 1606 is shown applied to baffles 1702 attached to the inner surfaces of the intermediate product stream conduits 1608. These examples are illustrative and non-limiting.

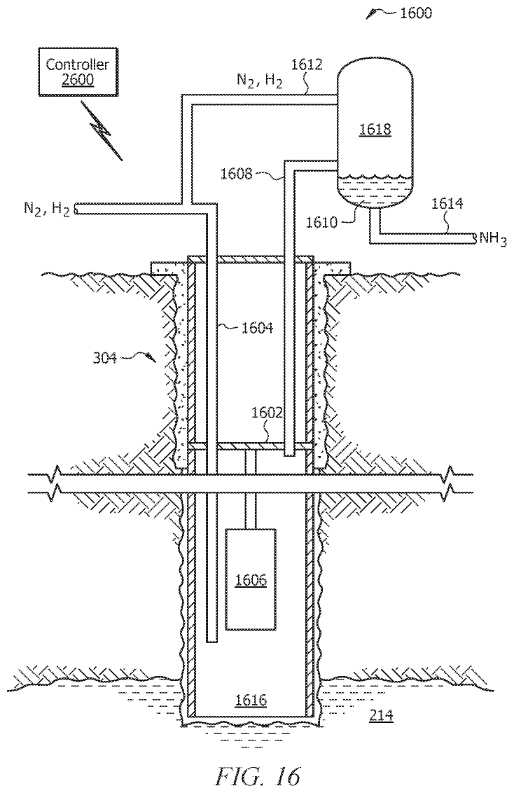

FIG. 18 is a schematic diagram of a third system 1800 for forming ammonia according to another illustrative embodiment. System 1800 may be used as the ammonia production reactor 506 of FIG. 5. The system 1800 is similar to the system 1600 in FIG. 16 except that the wellbore 302 includes a boiler casing 1802 at least partially bounding the reaction chamber 1616. The catalyst 1606 is shown applied to the inner surfaces of the boiler casing 1802. In an alternate embodiment, the catalyst 1606 can be applied to features coupled to the inner surface of the boiler casing 1802 which extend inwardly into the reaction chamber 1616. For example, a honeycomb structure (not shown) spanning a diameter of the wellbore 302 can be attached to the inner surfaces of the boiler casing 1802 and covered with catalyst 1606. In another example, a baffle system (not shown) can be attached to the inner surfaces of the boiler casing 1802 and covered with catalyst 1606. These inwardly extending features increase the contact between the reactants in the feed stream and the catalyst 1606 in the reaction chamber 1616, which promotes conversion to intermediate product(s) and/or end product(s).

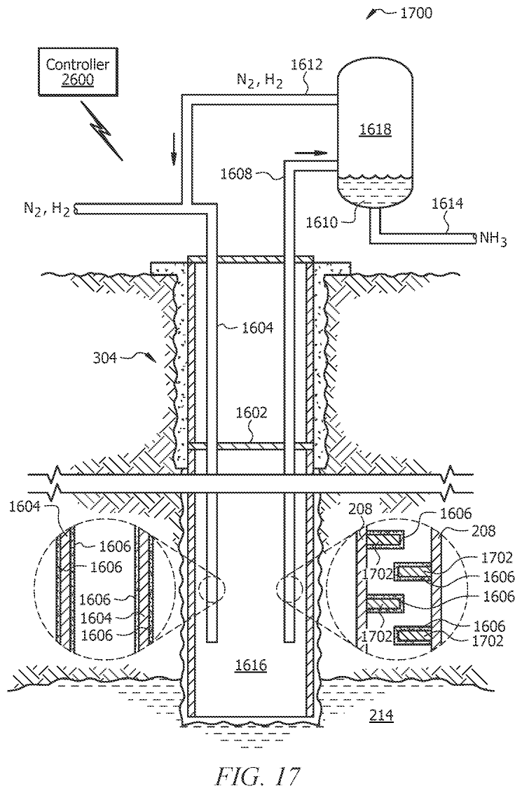

FIG. 19 is a schematic diagram of a fourth system 1900 for forming ammonia according to another illustrative embodiment. System 1900 may be used as the ammonia production reactor 506 of FIG. 5. The system 1900 is similar to the system 1600 in FIG. 16 except that the reaction chamber 1616 is housed within a reactor vessel 1902 positioned at the terminal end of the wellbore 302. Reactants are conveyed to the reaction chamber by the one or more feed stream conduits 1604. The reactants are converted to intermediate product(s) and/or end products(s) in the presence of the catalyst 1606 and heat obtained directly from the magma reservoir 214.

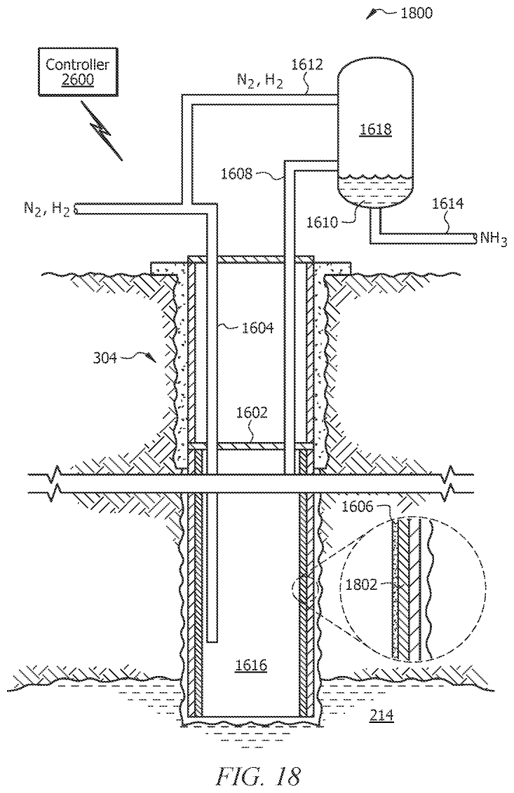

FIG. 20 is a more detailed view 2000 of example product recovery equipment 1618. The recovery equipment 1618 is a condenser that receives an intermediate product stream from one or more intermediate product stream conduits 1608. The condenser receives cooling fluid from cooling fluid conduit 2002 which can be used to separate a desired end product, such as ammonia, from unreacted reactants in processes that are known to those having ordinary skill in the art. The unreacted reactants are returned back to the reaction chamber via recycle stream conduit 1612 and ammonia is collected in the recovery equipment 1618 in liquid form and removed from the recovery equipment 1618 in stream conduit 1614.

The cooling fluid absorbs heat in the recovery equipment 1618 and is transformed into spent cooling fluid that is returned to the absorption chiller 2010 in spent cooling fluid conduit 2004 to be reused. As previously discussed, the absorption chiller 2010 uses heat obtained directly from a subterranean heat source, e.g., magma reservoir 214, to form cooling fluid that is delivered to the recovery equipment 1618. The absorption chiller 2010 receives heat transfer fluid 404c from heat exchanger 306 via heating fluid conduit 2006 and returns spent heat transfer fluid 406c to the heat exchanger 306 via spent heating fluid conduit 2008 to form a continuous circuit, as described above with respect to heat transfer fluid 404c and 406c. Operations of system 2000 may be controlled at least in part by a controller 2600 (see FIG. 26).

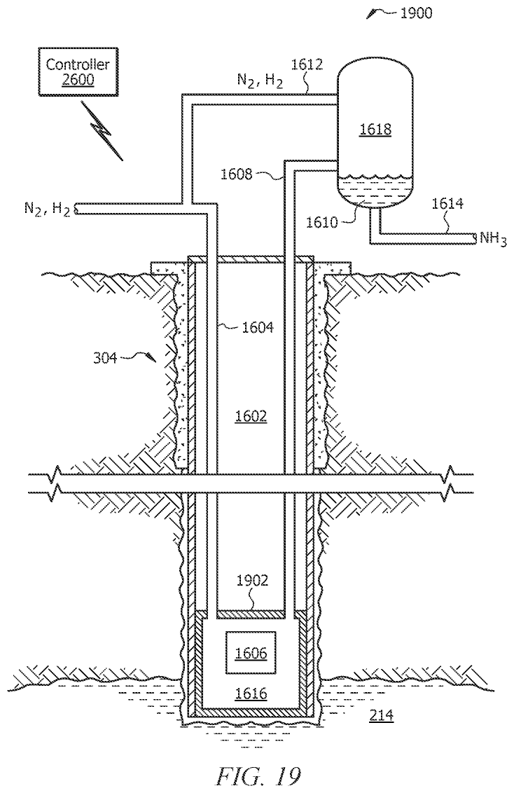

FIG. 21 is a flowchart of an example process 2100 for carrying out a thermochemical process to generate ammonia. The steps in process 2100 can be carried out in the various systems described with respect to FIGS. 5 and 16-20 above. Process 2100 may begin at step 2102 by injecting one or more feed streams into a reaction chamber, such as reaction chamber 1616. The reaction chamber 1616 is maintained at a reaction temperature using heat obtained directly from the magma reservoir 214. At step 2104, the one or more feed streams (e.g., the streams of hydrogen 514 and nitrogen 520 of FIG. 5) are maintained in the reaction chamber 1616 for a residence time to form a product stream that includes ammonia 522 of FIG. 5. The one or more products streams are then removed from the reaction chamber in step 2106.

Modifications, omissions, or additions may be made to process 2100 depicted in FIG. 21. Process 2100 may include more, fewer, or other steps. For example, at least certain steps may be performed in parallel or in any suitable order. All or a portion of the operations may be performed by or facilitated using information determined using the controller 2600 (see also FIG. 26).

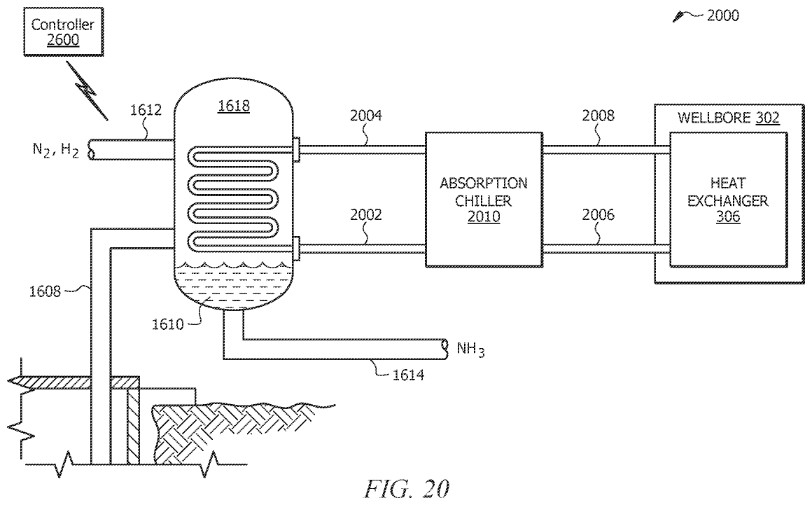

FIG. 22 is a flowchart of a process 2200 for processing a product stream formed by a thermochemical process according to an illustrative embodiment. Steps of process 2200 can be implemented following the removing step 2106 of process 2100 shown in FIG. 21. Process 2200 may begin at step 2202 by transferring the product stream to a separator vessel. Depending upon the type of the separator vessel and the type of separations process implemented, the separator vessel can be heated by heat transfer fluid 404c that obtained its heat directly from the magma reservoir 214 or cooled by cooling fluid formed by heat transfer fluid 404c that obtained its heat directly from the magma reservoir 214. Thus, process 2200 includes the optional step 2204 of supplying heating or cooling to the separator vessel using heat obtained directly from the magma reservoir 214. In step 2206, the one or more product streams are separated into one or more end products. One of the end products is ammonia.

Modifications, omissions, or additions may be made to process 2200 depicted in FIG. 22. Process 2200 may include more, fewer, or other steps. For example, at least certain steps may be performed in parallel or in any suitable order. All or a portion of the operations may be performed by or facilitated using information determined using the controller 2600 (see also FIG. 26).

### Example Electrochemical/Electrocatalytic Ammonia Production

In some cases, the ammonia production reactor 506 of FIG. 5 employs electrochemical and/or electrocatalytic processes to synthesize ammonia 522. For example, the ammonia production reactor 506 may include an electrolytic cell with a cathode capable of reducing the nitrogen 520 to form ammonia 522. The nitrogen may be reduced in the presence of the hydrogen 514 (or H″ obtained from the hydrogen 514) and/or in the presence of water. A heat exchanger may heat the electrolytic cell using energy obtained from the magma reservoir 214.

FIG. 23A shows an example of a geothermally heated electrolytic cell 2302 that may be used in the ammonia production reactor 506. The geothermally heated electrolytic cell 2302 reduces nitrogen 520 (or optionally preheated nitrogen 520′) to form ammonia 2310. The electrolytic cell 2302 includes an anode 2304, an electrolyte 2306, and a cathode 2308. The anode 2304 may be a metal or other material capable of forming protons through the oxidation of hydrogen. The cathode 2308 may include metals, oxides, nitrides, carbides, and/or any other materials active for the reduction of nitrogen to form nitride. The electrolyte 2306 is generally a material that conducts protons (i.e., H⁺). Examples of such materials include proton exchange membranes, molten salts (e.g., molten 0.5 NaOH/0.5 KOH), solid state electrolytes, and liquid electrolytes (aqueous solutions, organic solvents, and ionic liquids).

The hydrogen 514 (or preheated hydrogen 514′) is oxidized at the anode 2304 to form protons (HT). An example reaction at the anode 2304 is H₂→2H⁺+2e⁻. Meanwhile, the nitrogen 520 (or preheated nitrogen 520′) is reduced at the cathode 2308 to form nitride (N³⁻). An example reaction at the cathode 2308 is N₂+6e⁻→2N³⁻. Electricity 408 may be supplied to drive the reactions at the anode 2304 and cathode 2308. Protons formed at the anode 2304 migrate through the electrolyte 2306 and combine with the nitride to form ammonia according to N³⁻+3H⁺→NH₃.

The geothermally heated electrolytic cell 2302 may include heat exchangers 2314, 2316, and/or 2312 that preheat the reactant streams and/or heat the electrolytic cell 2302. In the example of FIG. 23A, heat exchanger 2314 preheats hydrogen 514 to form preheated hydrogen 514′. Preheated hydrogen 514′ is at an increased temperature to improve the reaction at the anode 2304 (e.g., by improving the efficiency of the anode reaction described above). Heat exchanger 2316 preheats nitrogen 520 to form preheated nitrogen 520′. Preheated nitrogen 520′ is at an increased temperature to improve the reaction at the cathode 2308 (e.g., by improving the efficiency of the cathode reaction described above). A heat exchanger 2312 (shown as tubing in the example of FIG. 23A for conciseness) may heat the electrolytic cell 2302. The heat exchanger 2312 receives heated heat transfer fluid 404c and uses the heated heat transfer fluid 404c to heat the electrolytic cell 2302. Heating the electrolytic cell 2302 may improve the anode and/or cathode reactions.

Controller 2600 may control one or more operations of the electrolytic cell 2302. For example, the controller 2600 may control amount of preheating of the hydrogen 514 by heat exchanger 2314 (e.g., by controlling flow rate of hydrogen 514 and/or heat transfer fluid 404c through the heat exchanger 2314). In this way, preheated hydrogen 514′ at a target temperature may be obtained to improve the ammonia production process. As another example, the controller 2600 may control amount of preheating of the nitrogen 520 by heat exchanger 2316 (e.g., by controlling flow rate of nitrogen 520 and/or heat transfer fluid 404c through the heat exchanger 2316). In this way, preheated nitrogen 520′ at a target temperature may be obtained to improve the ammonia production process. As yet another example, the controller 2600 may control operations of heat exchanger 2312 to heat the electrolytic cell 2302. For example, the controller 2600 may adjust the flow rate of heat transfer fluid 404c through the heat exchanger 2312 to achieve a target temperature or temperature range in the electrolytic cell 2302. The target temperature or temperature range may correspond to a temperature that improves efficiency of reactions at the anode 2304 and/or cathode 2308. The target temperature or temperature range may correspond to a temperature that improves proton transfer through the electrolyte 2306.

FIG. 23B shows an example of another geothermally heated electrolytic cell 2352 that may be used in the ammonia production reactor 506. The geothermally heated electrolytic cell 2352 shares elements in common with electrolytic cell 2302 but employs a different reaction involving nitrogen 520 and water 2362. The geothermally heated electrolytic cell 2352 reduces nitrogen 520 (or optionally preheated nitrogen 520′) to form ammonia 2310. The electrolytic cell 2352 includes an anode 2354, an electrolyte 2356, and a cathode 2358. The anode 2354 may be a metal or other material capable of oxidizing superoxide ions (O²⁻). The cathode 2358 may include metals, oxides, nitrides, carbides, and/or any other materials active for the reduction of nitrogen in the presence of water 2362. The electrolyte 2356 is generally a material that conducts protons (i.e., O²⁻). Examples of such materials include ion exchange membranes, molten salts (e.g., molten 0.5 NaOH/0.5 KOH), solid state electrolytes, and liquid electrolytes (aqueous solutions, organic solvents, and ionic liquids).

As with the electrolytic cell 2302 described above, nitrogen 520 (or preheated nitrogen 520′) is reduced at the cathode 2358 to form ammonia 2360. An example reaction at the cathode 2358 is N₂+4H₂O+4e⁻→2NH₃+H₂+4O²⁻. Meanwhile, O²⁻ formed at the cathode 2358 travels through the electrolyte 2356 and is oxidized at the anode 2354 to form oxygen. An example reaction at the anode 2354 is O²⁻→O₂+2e⁻. Electricity 408 may be supplied to drive the reactions at the anode 2304 and cathode 2308.

The geothermally heated electrolytic cell 2352 may include heat exchangers 2314, 2316, and/or 2312 that preheat the reactant streams, as described above with respect to FIG. 23A. In the example of FIG. 23B, heat exchanger 2314 preheats water 2362 to form preheated water 2362′. Also like the electrolytic cell 2302 described above, a controller 2600 may control one or more operations of the electrolytic cell 2352.

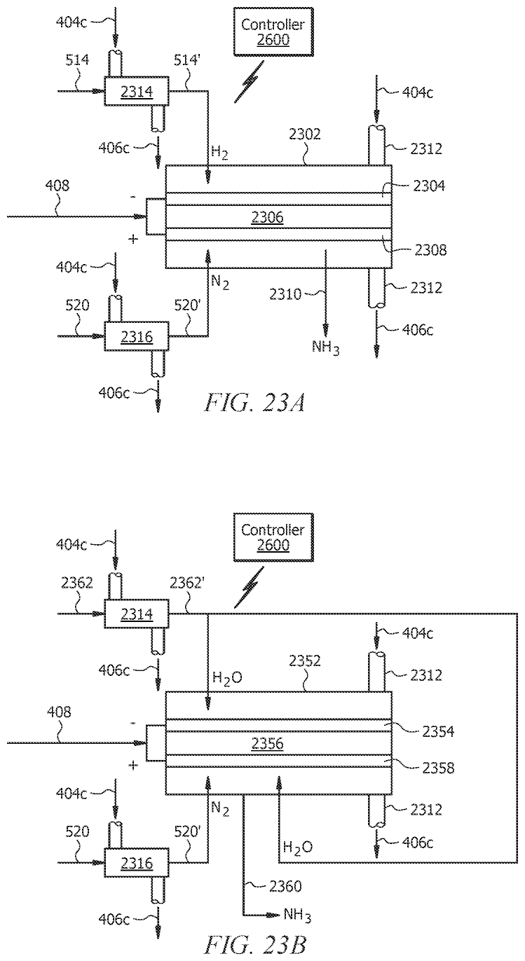

FIG. 24 is an example method 2400 of electrochemical ammonia production using the systems of this disclosure (e.g., systems of FIGS. 23A and 23B). The method 2400 may begin at step 2402 where reactants (e.g., nitrogen and hydrogen and/or nitrogen and water) are optionally preheated using heat obtained from the magma reservoir 214 (e.g., using heat transfer fluid 404c). At step 2404, the (optionally preheated) reactants are provided to an electrochemical cell (see, e.g., cells 2302 and 2352 of FIGS. 23A and 23B, respectively). At step 2406, the electrochemical cell is heated using heat obtained from the magma reservoir 214 (e.g., using heat transfer fluid 404c). At step 2408, a voltage (or current) is applied across the electrochemical cell to produce ammonia (see example reactions described above with respect to FIGS. 23A and 23B). At step 2410, the resulting ammonia is provided for post-processing (e.g., to separate ammonia from other products/reactants) and/or storage.

Modifications, omissions, or additions may be made to method 2400 depicted in FIG. 24. Method 2400 may include more, fewer, or other steps. For example, at least certain steps may be performed in parallel or in any suitable order. All or a portion of the operations may be performed using cells 2302 and/or 2352 of FIGS. 23A and 23B. Control of method 2400 may be performed at least in part using the controller 2600 (see also FIG. 26).

### Heat-Driven Process

FIG. 25 shows a schematic diagram of an example thermal process system 304 of FIGS. 3 and 4. The thermal process system 304 includes a steam separator 2502, a first turbine set 2504, a second turbine set 2508, a high-temperature/pressure thermochemical process 2512, a medium-temperature/pressure thermochemical process 2514, one or more lower temperature/pressure processes 2516a,b, and a controller 2600 (See FIG. 26) that controls, at least in part, the operations of system 304. The thermal process system 304 may include more or fewer components than are shown in the example of FIG. 25. For example, a thermal process system 304 used for power generation alone may omit the high-temperature/pressure thermochemical process 2512, medium-temperature/pressure thermochemical process 2514, and lower temperature/pressure processes 2516a,b. Similarly, a thermal process system 304 that is not used for power generation may omit the turbine sets 2504, 2508. As a further example, if heat transfer fluid is known to be received only in the gas phase, the steam separator 2502 may be omitted in some cases. The ability to tune the properties of the heat transfer fluid received from the unique wellbore 302 of FIGS. 3 and 4 facilitates improved and more flexible operation of the thermal process system 304. For example, the depth of the wellbore 302, the residence time of heat transfer fluid in the magma reservoir 214, the pressure achieved in the wellbore 302, and the like can be selected or adjusted to provide desired heat transfer fluid properties at the thermal process system 304.

In the example of FIG. 25, the steam separator 2502 is connected to the wellbore 302 that extends between a surface and the underground magma reservoir. The steam separator 2502 separates a vapor-phase heat transfer fluid (e.g., steam) from liquid-phase heat transfer fluid (e.g., condensate formed from the vapor-phase heat transfer fluid). A stream 2520 received from the wellbore 302 may be provided to the steam separator 2502. In some cases, all of stream 2518 is provided in stream 2520. In other cases, a fraction or none of stream 2518 is provided to the steam separator 2502. Instead, all or a portion of the stream 2518 may be provided as stream 2528 which may be provided to the first turbine set 2504 and/or to a high-pressure thermal process 2512 in stream 2529. The thermal process 2512 may be a thermochemical reaction requiring high temperatures and/or pressures (e.g., temperatures of between 500 and 2,000° F. and/or pressures of between 1,000 and 4,500 psig), such as the geothermally powered hydrogen production system 500. One or more valves (not shown for conciseness) may be used to control the direction of stream 2520 to the steam separator 2502, first turbine set 2504, and/or thermal process 2512. A vapor-phase stream 2522 of heat transfer fluid from the condenser may be sent to the first turbine set 2504 and/or the thermal process 2512 via stream 2526. A liquid-phase stream 2524 of heat transfer fluid from the steam separator 2502 may be provided back to the wellbore 302 and/or to condenser 2542. The condenser 2542 is any appropriate type of condenser capable of condensing a vapor-phase fluid. The condenser 2542 may be coupled to a cooling or refrigeration unit, such as a cooling tower (not shown for conciseness).

The first turbine set 2504 includes one or more turbines 2506a,b. In the example of FIG. 25, the first turbine set includes two turbines 2506a,b. However, the first turbine set 2504 can include any appropriate number of turbines for a given need. The turbines 2506a,b may be any known or yet to be developed turbine for electricity generation. The first turbine set 2504 is connected to the steam separator 2502 and is configured to generate electricity from the vapor-phase heat transfer fluid (e.g., steam) received from the steam separator 2502 (vapor-phase stream 2522). A stream 2530 exits the first turbine set 2504. The stream 2530 may be provided to the condenser 2542 and then back to the wellbore 302. The condenser 2542 may be cooled using a heat driven chiller, such as the absorption chiller 508 of FIG. 5.

If the heat transfer fluid is at a sufficiently high temperature, as may be uniquely and more efficiently possible using the wellbore 302, a stream 2532 of vapor-phase heat transfer fluid may exit the first turbine set 2504. Stream 2532 may be provided to a second turbine set 2508 to generate additional electricity. The turbines 2510a,b of the second turbine set 2508 may be the same as or similar to turbines 2506a,b, described above.

All or a portion of stream 2532 may be sent as vapor-phase stream 2534 to a thermal process 2514. Process 2514 is generally a process requiring vapor-phase heat transfer fluid at or near the conditions of the heat transfer fluid exiting the first turbine set 2504. For example, the thermal process 2514 may include one or more thermochemical processes requiring steam or another heat transfer fluid at or near the temperature and pressure of stream 2532 (e.g., temperatures of between 250 and 1,500° F. and/or pressures of between 500 and 2,000 psig). The second turbine set 2508 may be referred to as “low pressure turbines” because they operate at a lower pressure than the first turbine set 2504. Fluid from the second turbine set 2508 is provided to the condenser 2542 via stream 2536 to be condensed and then sent back to the wellbore 302 via stream 2536.

An effluent stream 2538 from the second turbine set 2508 may be provided to one or more thermal processes 2516a,b. Thermal processes 2516a,b generally require less thermal energy than thermal processes 2512 and 2514, described above (e.g., processes 2516a,b may be performed temperatures of between 22° and 700° F. and/or pressures of between 15 and 120 psig). As an example, processes 2516a,b may include water distillation processes, heat-driven chilling processes, space heating processes, agriculture processes, aquaculture processes, and/or the like. For instance, an example heat-driven chiller process 2516a may be implemented using one or more heat driven chillers. Heat driven chillers can be implemented, for example, in data centers, crypto-currency mining facilities, or other locations in which undesirable amounts of heat are generated. Heat driven chillers, also referred to as absorption cooling systems, use heat to create chilled water. Heat driven chillers can be designed as direct-fired, indirect-fired, and heat-recovery units. When the effluent includes low pressure steam, indirect-fired units may be preferred. An effluent stream 2540 from all processes 2512, 2514, 2516a,b, may be provided back to the wellbore 302.

### Example Controller

FIG. 26 illustrates an example controller 2600 for performing various operations described in this disclosure. The example controller 2600 of FIG. 26 includes a processor 2602, memory 2604, and interface 2606. The processor 2602 is electronic circuitry that coordinates operations of the controller 2600. The processor 2602 may be a programmable logic device, a microcontroller, a microprocessor, or any suitable combination of these or similar components. The processor 2602 is communicatively coupled to the memory 2604 and interface 2606. The processor 2602 may be one or more processors. The processor 2602 may be implemented using hardware and/or software.

The interface 2606 enables wired and/or wireless communications of data or other signals between the controller 2600 and other devices, systems, or domain(s), such as pumps, valves, temperature control hardware, and the like. The interface 2606 is an electronic circuit that is configured to enable communication between these devices. For example, the interface 2606 may include one or more serial ports (e.g., USB ports or the like) and/or parallel ports (e.g., any type of multi-pin port) for facilitating this communication. As a further example, the interface 2606 may include a network interface such as a WIFI interface, a local area network (LAN) interface, a wide area network (WAN) interface, a modem, a switch, or a router. The processor 2602 may send and receive data using the interface 2606. For instance, the interface 2606 may send instructions to provide heated heat transfer fluid 404c to a system component needing heating. The interface 2606 may provide signals to cause a display to show an indication of a temperature of a given system component. The interface 2606 may receive signals from an input device that are used to establish target parameter value(s) 2608, such as setpoint temperatures or temperature ranges for various systems components.

The memory 2604 stores any data, instructions, logic, rules, or code to execute the functions of the controller 2600. For example, the memory 2604 may store target parameter value(s) 2608 and measured parameters value(s) 2610. For example, a target parameter value 2608 may be a setpoint temperatures for the hydrogen production subsystem 502, the nitrogen production subsystem 504, and/or the ammonia production reactor 506. The measured parameter values 2610 may include temperatures of these components as measured by appropriately deployed temperature sensors. The memory 2604 may include one or more disks, tape drives, solid-state drives, and/or the like. The memory 2604 may store programs, instructions, and data that are read during program execution. The memory 2604 may be volatile or non-volatile and may comprise read-only memory (ROM), random-access memory (RAM), ternary content-addressable memory (TCAM), dynamic random-access memory (DRAM), and static random-access memory (SRAM).

### ADDITIONAL EMBODIMENTS

The following descriptive embodiments are offered in further support of the one or more aspects of this disclosure.

Embodiment 1. A system for producing ammonia, the system comprising:
a wellbore extending from a surface into an underground magma reservoir;
a hydrogen production subsystem comprising a hydrogen-generation reactor configured to generate hydrogen using energy obtained from the underground magma reservoir;
a nitrogen production subsystem configured to capture nitrogen from air using the energy obtained from the underground magma reservoir; and
a reaction chamber configured to:
   receive at least a portion of the hydrogen generated by the hydrogen production subsystem;
   receive at least a portion of the nitrogen captured by the nitrogen production subsystem;
   heat the received hydrogen and the received nitrogen to at least a reaction temperature using the energy obtained from the underground magma reservoir; and
   cause the heated hydrogen to contact the heated nitrogen for a residence time to form the ammonia, and optionally one or more of the following limitations:
   wherein:
the wellbore is configured to heat a heat transfer fluid via heat transfer with the underground magma reservoir, thereby forming heated heat transfer fluid;
the hydrogen-generation reactor is further configured to generate the hydrogen using thermal energy obtained from the heated heat transfer fluid; and
the reaction chamber is further configured to heat the received hydrogen and the received nitrogen to at least the reaction temperature using the heated heat transfer fluid;
   wherein the hydrogen-generation reactor is a vessel at a temperature sufficient to support thermochemical water splitting;
   wherein the vessel is disposed within the wellbore and located at least partially within the underground magma reservoir;
   wherein the hydrogen-generation reactor is a vessel located externally to the wellbore, and wherein the vessel is heated by the energy obtained from the underground magma reservoir;
   wherein the hydrogen-generation reactor comprises:
a heat exchanger configured to heat a feed stream using the energy obtained from the underground magma reservoir, thereby forming a heated feed stream, wherein the feed stream comprises water; and
an electrolyzer configured to generate the hydrogen from the heated feed stream via electrolysis of the water of the heated feed stream;
   wherein the system further comprises one or more turbines configured to use the energy obtained from the underground magma reservoir to generate electricity, and wherein the generated electricity is used to drive the electrolysis of the water of the heated feed stream;
   wherein the nitrogen production subsystem comprises a pressure swing adsorption system comprising:
a compressor configured to compress air using energy obtained from the underground magma reservoir; and
a vessel configured to receive and store the compressed air, the vessel comprising an absorbent or adsorbent material that removes oxygen from the compressed air;
   wherein the nitrogen production subsystem comprises a fractional distillation system comprising:
an absorption chiller configured to generate a cooling fluid using the energy obtained from the underground magma reservoir;
an air cooler configured to cool air using the cooling fluid;
an expansion device configured to liquefy the cooled air; and
a distillation column configured to receive the liquified air and separate the nitrogen from oxygen in the liquified air.
   wherein the reaction chamber is disposed within the wellbore;
   wherein the reaction chamber is located at least partially within the underground magma reservoir; and
   wherein the reaction chamber comprises:
an electrolytic cell comprising a cathode configured to reduce the received nitrogen to form the ammonia; and
a heat exchanger configured to heat the electrolytic cell using the energy obtained from the underground magma reservoir.

Embodiment 2. A method for producing ammonia, the method comprising:
obtaining, via a wellbore extending into a magma reservoir, energy from the magma reservoir;
generating hydrogen using the energy obtained from the magma reservoir;
capturing nitrogen from air using the energy obtained from the magma reservoir;
heating the hydrogen and the nitrogen to at least a reaction temperature using the energy obtained from the magma reservoir; and
causing the heated hydrogen to contact the heated nitrogen for a residence time to form the ammonia, and optionally one or more of the following limitations:
   wherein:
obtaining the energy from the wellbore further comprises heating a heat transfer fluid via heat transfer with the magma reservoir, thereby forming heated heat transfer fluid;
generating the hydrogen further comprises generating the hydrogen using thermal energy obtained from the heated heat transfer fluid; and
heating the hydrogen and the nitrogen further comprises heating the hydrogen and the nitrogen to at least the reaction temperature using the heated heat transfer fluid;
   wherein the method further comprises generating the hydrogen in a vessel disposed within the wellbore and located at least partially within the magma reservoir;
   wherein the method further comprises generating the hydrogen in a vessel located externally to the wellbore, wherein the vessel is heated by the energy obtained from the magma reservoir;
   wherein the method further comprises generating the hydrogen by:
heating a feed stream using the energy obtained from the magma reservoir, thereby forming a heated feed stream, wherein the feed stream comprises water;
providing the heated feed stream to an electrolyzer; and
generating the hydrogen from the heated feed stream via electrolysis of the water of the heated feed stream;
   wherein the method further comprises:
   generating, using one or more turbines, electricity with the energy obtained from the magma reservoir; and
using the generated electricity to drive the electrolysis of the water of the heated feed stream;
   wherein the method further comprises capturing the nitrogen by:
compressing the air using the energy obtained from the magma reservoir;
storing the compressed air in a vessel comprising an absorbent or adsorbent material that removes oxygen from the compressed air; and
releasing the nitrogen from the vessel;
   wherein the method further comprises capturing the nitrogen by:
generating a cooling fluid using the energy obtained from the magma reservoir;
cooling the air using the cooling fluid;
expanding the cooled air to liquefy the cooled air; and
separating, using a distillation column, the nitrogen from oxygen in the liquified air;
   wherein the method further comprises heating the hydrogen and the nitrogen to at least the reaction temperature in a reaction chamber is disposed within the wellbore and located at least partially within the magma reservoir; and
   wherein the method further comprises:
reducing, using an electrolytic cell, the nitrogen to form the ammonia; and
heating the electrolytic cell using the energy obtained from the magma reservoir.

Embodiment 3. A reactor for producing ammonia, the reactor comprising a reaction chamber configured to:
receive hydrogen generated using energy obtained from a magma reservoir;
receive nitrogen;
heat the received hydrogen and the received nitrogen to at least a reaction temperature using the energy obtained from the magma reservoir; and
cause the heated hydrogen to contact the heated nitrogen for a residence time to form ammonia, and optionally one or more of the following limitations:
   wherein the reaction chamber is disposed within a wellbore extending into the magma reservoir;
   wherein the reaction chamber is located at least partially within the magma reservoir; and
   wherein the reaction chamber comprises:
an electrolytic cell comprising a cathode configured to reduce the received nitrogen to form the ammonia; and
a heat exchanger configured to heat the electrolytic cell using the energy obtained from the magma reservoir.

Embodiment 4. A reactor for producing ammonia, the reactor comprising:
an electrolytic cell configured to receive nitrogen captured using energy obtained from a magma reservoir, the electrolytic cell comprising a cathode configured to reduce the received nitrogen to form the ammonia; and
a heat exchanger configured to heat the electrolytic cell using the energy obtained from the magma reservoir, and optionally one or more of the following limitations:
   wherein the reactor is disposed within a wellbore extending into the magma reservoir and located at least partially within the magma reservoir; and
   wherein the electrolytic cell is further configured to receive electricity generated by one or more turbines powered by the energy obtained from the magma reservoir.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Moreover, items shown or discussed as coupled or directly coupled or communicating with each other may be indirectly coupled or communicating through some interface device, or intermediate component whether electrically, mechanically, fluidically, or otherwise.

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions, and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

We claim:

1. A system for producing ammonia, the system comprising:
a wellbore extending from a surface into an underground magma reservoir;
a hydrogen production subsystem comprising a hydrogen-generation reactor configured to generate hydrogen using energy obtained from the underground magma reservoir;
a nitrogen production subsystem configured to capture nitrogen from air using the energy obtained from the underground magma reservoir; and
a reaction chamber configured to:
receive at least a portion of the hydrogen generated by the hydrogen production subsystem;
receive at least a portion of the nitrogen captured by the nitrogen production subsystem;
heat the received hydrogen and the received nitrogen to at least a reaction temperature using the energy obtained from the underground magma reservoir; and
cause the heated hydrogen to contact the heated nitrogen for a residence time to form the ammonia.

2. The system of claim 1, wherein:
the wellbore is configured to heat a heat transfer fluid via heat transfer with the underground magma reservoir, thereby forming heated heat transfer fluid;
the hydrogen-generation reactor is further configured to generate the hydrogen using thermal energy obtained from the heated heat transfer fluid; and
the reaction chamber is further configured to heat the received hydrogen and the received nitrogen to at least the reaction temperature using the heated heat transfer fluid.

3. The system of claim 1, wherein the hydrogen-generation reactor is a vessel at a temperature sufficient to support thermochemical water splitting.

4. The system of claim 3, wherein the vessel is disposed within the wellbore and located at least partially within the underground magma reservoir.

5. The system of claim 1, wherein the hydrogen-generation reactor is a vessel located externally to the wellbore, wherein the vessel is heated by the energy obtained from the underground magma reservoir.

6. The system of claim 1, wherein the hydrogen-generation reactor comprises:
a heat exchanger configured to heat a feed stream using the energy obtained from the underground magma reservoir, thereby forming a heated feed stream, wherein the feed stream comprises water; and
an electrolyzer configured to generate the hydrogen from the heated feed stream via electrolysis of the water of the heated feed stream.

7. The system of claim 6, further comprising one or more turbines configured to use the energy obtained from the underground magma reservoir to generate electricity, wherein the generated electricity is used to drive the electrolysis of the water of the heated feed stream.

8. The system of claim 1, wherein the nitrogen production subsystem comprises a pressure swing adsorption system comprising:
a compressor configured to compress air using energy obtained from the underground magma reservoir; and
a vessel configured to receive and store the compressed air, the vessel comprising an absorbent or adsorbent material that removes oxygen from the compressed air.

9. The system of claim 1, wherein the nitrogen production subsystem comprises a fractional distillation system comprising:
an absorption chiller configured to generate a cooling fluid using the energy obtained from the underground magma reservoir;
an air cooler configured to cool air using the cooling fluid;
an expansion device configured to liquefy the cooled air; and
a distillation column configured to receive the liquified air and separate the nitrogen from oxygen in the liquified air.

10. The system of claim 1, wherein the reaction chamber is disposed within the wellbore.

11. The system of claim 1, wherein the reaction chamber is located at least partially within the underground magma reservoir.

12. The system of claim 1, wherein the reaction chamber comprises:
an electrolytic cell comprising a cathode configured to reduce the received nitrogen to form the ammonia; and
a heat exchanger configured to heat the electrolytic cell using the energy obtained from the underground magma reservoir.

13. A method for producing ammonia, the method comprising:
obtaining, via a wellbore extending into a magma reservoir, energy from the magma reservoir;
generating hydrogen using the energy obtained from the magma reservoir;
capturing nitrogen from air using the energy obtained from the magma reservoir;
heating the hydrogen and the nitrogen to at least a reaction temperature using the energy obtained from the magma reservoir; and
causing the heated hydrogen to contact the heated nitrogen for a residence time to form the ammonia.

14. The method of claim 13, wherein:
obtaining the energy from the wellbore further comprises heating a heat transfer fluid via heat transfer with the magma reservoir, thereby forming heated heat transfer fluid;
generating the hydrogen further comprises generating the hydrogen using thermal energy obtained from the heated heat transfer fluid; and
heating the hydrogen and the nitrogen further comprises heating the hydrogen and the nitrogen to at least the reaction temperature using the heated heat transfer fluid.

15. The method of claim 13, further comprising generating the hydrogen in a vessel disposed within the wellbore and located at least partially within the magma reservoir.

16. The method of claim 13, further comprising generating the hydrogen in a vessel located externally to the wellbore, wherein the vessel is heated by the energy obtained from the magma reservoir.

17. The method of claim 13, further comprising generating the hydrogen by:
heating a feed stream using the energy obtained from the magma reservoir, thereby forming a heated feed stream, wherein the feed stream comprises water;
providing the heated feed stream to an electrolyzer; and
generating the hydrogen from the heated feed stream via electrolysis of the water of the heated feed stream.

18. The method of claim 17, further comprising:
generating, using one or more turbines, electricity with the energy obtained from the magma reservoir; and
using the generated electricity to drive the electrolysis of the water of the heated feed stream.

19. The method of claim 13, further comprising capturing the nitrogen by:
compressing the air using the energy obtained from the magma reservoir;
storing the compressed air in a vessel comprising an absorbent or adsorbent material that removes oxygen from the compressed air; and
releasing the nitrogen from the vessel.

20. The method of claim 13, further comprising capturing the nitrogen by:
generating a cooling fluid using the energy obtained from the magma reservoir;
cooling the air using the cooling fluid;
expanding the cooled air to liquefy the cooled air; and
separating, using a distillation column, the nitrogen from oxygen in the liquified air.

21. The method of claim 13, further comprising heating the hydrogen and the nitrogen to at least the reaction temperature in a reaction chamber is disposed within the wellbore and located at least partially within the magma reservoir.

22. The method of claim 13, further comprising:
reducing, using an electrolytic cell, the nitrogen to form the ammonia; and
heating the electrolytic cell using the energy obtained from the magma reservoir.

23. A reactor for producing ammonia, the reactor comprising a reaction chamber configured to:
receive hydrogen generated using energy obtained from a magma reservoir;
receive nitrogen;
heat the received hydrogen and the received nitrogen to at least a reaction temperature using the energy obtained from the magma reservoir; and
cause the heated hydrogen to contact the heated nitrogen for a residence time to form ammonia.

24. The reactor of claim 23, wherein the reaction chamber is disposed within a wellbore extending into the magma reservoir.

25. The reactor of claim 23, wherein the reaction chamber is located at least partially within the magma reservoir.

26. The reactor of claim 23, wherein the reaction chamber comprises:
an electrolytic cell comprising a cathode configured to reduce the received nitrogen to form the ammonia; and
a heat exchanger configured to heat the electrolytic cell using the energy obtained from the magma reservoir.

27. A reactor for producing ammonia, the reactor comprising:
an electrolytic cell configured to receive nitrogen captured using energy obtained from a magma reservoir, the electrolytic cell comprising a cathode configured to reduce the received nitrogen to form the ammonia; and
a heat exchanger configured to heat the electrolytic cell using the energy obtained from the magma reservoir.

28. The reactor of claim 27, wherein the reactor is disposed within a wellbore extending into the magma reservoir and located at least partially within the magma reservoir.

29. The reactor of claim 27, wherein the electrolytic cell is further configured to receive electricity generated by one or more turbines powered by the energy obtained from the magma reservoir.
